(19) United States
(12) Patent Application Publication
(10) Pub. No.: US 2013/0327928 A1
(43) Pub. Date: Dec. 12, 2013

(54) Apparatus for Manipulating Plasmons

(71) Applicants: Gary Leach, British Columbia (CA); Murat Cetinbas, Vancouver (CA); Jayna Chan, Windsor (CA); Tom Johansson, Coquitlam (CA); Philip Kubik, Vancouver (CA); Claire McCague, Delta (CA); Finlay McNab, Vancouver (CA); Andras Pattantyus-Abraham, Burnaby (CA); Haijun Qiao, Burnaby (CA); Xin Zhang, New Westminster (CA)

(72) Inventors: Gary Leach, British Columbia (CA); Murat Cetinbas, Vancouver (CA); Jayna Chan, Windsor (CA); Tom Johansson, Coquitlam (CA); Philip Kubik, Vancouver (CA); Claire McCague, Delta (CA); Finlay McNab, Vancouver (CA); Andras Pattantyus-Abraham, Burnaby (CA); Haijun Qiao, Burnaby (CA); Xin Zhang, New Westminster (CA)

(21) Appl. No.: 13/813,143

(22) PCT Filed: Jul. 29, 2011
(86) PCT No.: PCT/CA2011/050471

§ 371 Date: Jun. 3, 2013

Related U.S. Application Data
(60) Provisional application No. 61/369,589, filed on Jul. 30, 2010.

(51) Int. Cl. G01J 1/04

(52) U.S. Cl. CPC G01J 1/0407
USPC 250/216; 156/280

(57) ABSTRACT

The present invention provides an apparatus and method for manipulating plasmons. The apparatus comprises a support structure and two or more plasmon-responsive elements. The plasmon-responsive elements are disposed adjacent the support structure and configured for interaction with electromagnetic radiation and generation of a plurality of plasmons. At least a first of the plasmon-responsive elements is configured to manipulate interaction of at least some of the plurality of plasmons with at least a second of the plasmon-responsive elements.

### FIELD OF THE INVENTION

The present invention pertains in general to surface plasmon devices and more specifically, to an apparatus for manipulating plasmons.

### BACKGROUND

Plasmonic effects have been the focus of intense investigation both experimentally and theoretically due to their potential for usefully coupling electromagnetic energy into devices. The interaction of electromagnetic waves with metal/dielectric structures can give rise to surface plasmon polaritons (SPPs) or localized surface plasmon resonant (LSPR) excitations, in which these plasmonic excitations correspond to coherent oscillations of electrons at the metal/dielectric interface.

Potential uses of plasmons may include a variety of applications based on coupling of plasmons to optical emitters, plasmon focusing, hybridized plasmonic modes in nanoscale metal shells, nanoscale wave guiding, nanoscale optical antennas, plasmonic integrated circuits, nanoscale switches, plasmonic lasers, surface-plasmon-enhanced light-emitting diodes; imaging below the diffraction limit and materials with negative refractive index. Example applications may include solar-energy conversion devices, surface plasmon amplification by stimulated emission of radiation (SPACERS), plasmon-based modulators, interferometers, beam splitters, detectors, subwavelength diffraction gratings to enhance the free-space coupling of light into devices and dielectric slab waveguides as a means to couple light efficiently into waveguides, for example.

With respect to current commercial photovoltaic technology, high efficiency solar cells are costly, due to the requirement for significant amounts of high purity silicon. Use of alternative semiconducting materials which absorb components of the solar spectrum more efficiently allow PV manufacturing with less material and lower associated costs. However, these thin film technologies also suffer from lower power conversion efficiencies. Yet known photovoltaic cells typically achieve no more than about 20-25% conversion efficiency and designs that provide better conversion efficiencies, for example multi-junction semiconductor solar cells, are more complex and their manufacture is more costly. It is desirable to improve solar cell efficiencies without significant increase in cost through the implementation of plasmonic materials.

Current approaches to enhance photovoltaic cells using plasmonic effects make use of the scattering ability of plasmonic particles to increase the effective interaction of incident solar energy with the light-absorbing semiconductor material of the photovoltaic device, resulting in greater absorption efficiency and/or the requirement for less of the costly semiconducting material in the device. Other approaches to improve the efficiency of existing semiconductor-based photovoltaic technologies employ plasmonic nanoparticles to augment the wavelength range of absorption of the photovoltaic device, thereby increasing its power conversion efficiency. Recent reviews of some promising strategies to incorporate plasmonic elements into photovoltaic technology are summarized by H. A. Atwater and Polman, Plasmonics for improved photovoltaic (PV) devices, Nature Materials 9 (2010), 205; S. Pillai and M. A. Green, Plasmonics for photovoltaic applications, Sol. Energy Mater. Sol. Cells, (2010), doi:10.1016/j.solmat.2010.02.046;

Other plasmon-based photovoltaic systems include that described in U.S. Pat. No. 4,482,778, also listed above, provides an example of an integrally formed SPP-based spectrophotovoltaic system that includes narrow-band photovoltaic cells. United States Patent Application Publication No. 2010/0175745 describes photovoltaic devices that are driven by photoemission of “hot” electrons from the surface of a nanostructured metal in contact with a Schottky barrier, however these devices have a limited conversion efficiency.

Therefore there is a need for an apparatus for manipulating plasmons which overcomes one or more problems in the art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus for manipulating plasmons. In accordance with an aspect of the present invention there is provided an apparatus for manipulating plasmons, the apparatus comprising: a support structure; two or more plasmon-responsive elements positioned adjacent the support structure, the two or more plasmon-responsive elements configured for interaction with electromagnetic radiation and generation of a plurality of plasmons, wherein at least a first of the two or more plasmon-responsive elements is configured to manipulate interaction of at least some of the plurality of plasmons with at least a second of the two or more plasmon-responsive elements, said two or more plasmon-responsive elements configured as nanoscale structures with a nanoscale spacing therebetween; and a secondary layer disposed on the support structure and the two or more plasmon-responsive elements, said secondary layer forming an interface with the two or more plasmon-responsive elements such that the interface is proximate a location of generation of the plurality of plasmons.

In accordance with another aspect of the present invention, there is provided a method for fabricating an apparatus for manipulating plasmons, the method comprising the steps of: fabricating a support structure; positioning two or more plasmon-responsive elements on the support structure, the two or more plasmon-responsive elements configured for interaction with electromagnetic radiation and generation of a plurality of plasmons, wherein at least a first of the two or more plasmon-responsive elements is configured to manipulate interaction of at least some of the plurality of plasmons with at least a second of the two or more plasmon-responsive elements, said two or more plasmon-responsive elements configured as nanoscale structures with a nanoscale spacing therebetween; and disposing a secondary layer on the support structure and the two or more plasmon-responsive elements, said secondary layer forming an interface with the two or more plasmon-responsive elements such that the interface is proximate a location of generation of the plurality of plasmons.

### BRIEF DESCRIPTION OF THE FIGURES

FIG. 1 illustrates a sectional view of an apparatus according to embodiments of the present invention.

FIG. 2A illustrates a sectional view of an apparatus according to embodiments of the present invention.

FIG. 2B illustrates a sectional view of an apparatus according to embodiments of the present invention.

FIG. 2C illustrates another sectional view of the apparatuses illustrated in FIGS. 2A and/or 2B as indicated therein.

FIG. 2D illustrates another sectional view of the apparatuses illustrated in FIGS. 2A and/or 2B as indicated therein.

FIG. 3A illustrates a sectional view of an apparatus according to embodiments of the present invention.

FIG. 3B illustrates a sectional view of an apparatus according to embodiments of the present invention.

FIG. 3C illustrates a sectional view of an apparatus according to embodiments of the present invention.

FIG. 3D illustrates a sectional view of an apparatus according to embodiments of the present invention.

FIG. 4A illustrates a sectional view of an apparatus according to embodiments of the present invention.

FIG. 4B illustrates a sectional view of an apparatus according to embodiments of the present invention.

FIG. 4C illustrates a sectional view of an apparatus according to embodiments of the present invention.

FIG. 5A illustrates a sectional view of an apparatus according to embodiments of the present invention.

FIG. 5B illustrates a sectional view of an apparatus according to embodiments of the present invention.

FIG. 5C illustrates a sectional view of an apparatus according to embodiments of the present invention.

FIG. 6 illustrates a sectional view of an apparatus according to embodiments of the present invention.

FIGS. 7A and 7B illustrate sectional views of an example apparatus according to embodiments of the present invention.

FIG. 8A illustrates a reflectivity spectrum of an example apparatus according to FIGS. 7A and 7B.

FIG. 8B illustrates an electric field density distribution in arbitrary units for a plasmon responsive element of an example apparatus according to FIGS. 7A and 7B at 610 nm wavelength.

FIG. 8C illustrates an electric field density distribution in arbitrary units for a plasmon responsive element of an example apparatus according to FIGS. 8A and 8B at 748 nm wavelength.

FIG. 8D illustrates the electric field density distribution of FIG. 9C scaled relative to the intensity of the impinging light.

FIGS. 9A and 9B illustrate sectional views of an apparatus according to embodiments of the present invention.

FIG. 10 illustrates a reflectivity spectrum of an apparatus according to an embodiment of the present invention.

FIG. 11 illustrates operational characteristics of five apparatuses according to embodiments of the present invention.

FIG. 12 illustrates reflectivity spectra of apparatus having prismatic plasmon-responsive elements with a quadratic base and different heights according to embodiments of the present invention.

FIG. 13 illustrates reflectivity spectra of apparatus having prismatic plasmon-responsive elements with a quadratic base disposed at different separations according to embodiments of the present invention.

FIG. 14 illustrates reflectivity spectra of apparatus having cylindrical plasmon-responsive elements of different radius and alternating heights according to embodiments of the present invention.

FIG. 15 illustrates I-V operational characteristics of the apparatus further characterized in FIG. 9A.

FIG. 16 illustrates a sectional view of an apparatus according to embodiments of the present invention.

FIG. 17 illustrates experimental and calculated reflectivity spectra for a linewidth of 215 nm for the apparatus illustrated in FIG. 16.

FIGS. 18A and 18B illustrated experimental and calculated reflectivity spectra, respectively, for linewidths from 180 nm to 300 nm for the apparatus illustrated in FIG. 16.

FIGS. 19A, 19B and 19C show a scanning electron micrograph of A) a patterned borosilicate glass substrate with nanocylinders; B) a multilayer coating on the nanocylinders after coating with ZnO:Al, ZnO and Ag and C) a cross section of the multilayer coating on the nanocylinders, in accordance with embodiments of the present invention.

FIG. 20 illustrates the normal incidence reflectivity spectrum of the apparatus of FIG. 19.

FIG. 21 illustrates a sectional view of an apparatus in accordance with embodiments of the present invention, wherein the oxide films are in the nanoscale and the surface plasmon is generated via evanescent coupling.

FIG. 22 illustrates the reflectivity of the apparatus illustrated in FIG. 21 as a function of incidence angle.

FIG. 23 illustrates experimental current-voltage responses of the apparatus illustrated in FIG. 21.

FIG. 24 illustrates a section view of an apparatus in accordance with embodiments of the present invention.

FIG. 25 illustrates the reflectivity spectrum for the apparatus illustrated in FIG. 24, wherein the period of the plasmon responsive elements is 400 nm.

FIG. 26 illustrates the reflectivity spectrum for the apparatus illustrated in FIG. 24, as a function of the period of the plasmon responsive elements.

### DETAILED DESCRIPTION OF THE INVENTION

### Definitions

As used herein the term “multilayer junction” refers to a combination of two or more operatively connected regions of materials wherein pairs of regions can contact one another in a substantially point, line, planar, regular or irregular interface or a combination thereof. Different interfaces, portions of different interfaces or portions of an interface of a multilayer junction may be parallel, oblique or perpendicular to one another. A multilayer junction comprises two or more layers, wherein each layer can be a crystalline, polycrystalline or amorphous material including organic and/or inorganic materials; or metallic, semi-metallic, semiconducting or insulating/dielectric, superconducting and/or other material.

As used herein the term “plasmon-responsive element” refers to an electrical, optical and/or electro-optical element that can provide at least one characteristic that can be affected by plasmons. In particular a plasma responsive element is configured to manipulate and/or generate one or more plasmons upon interaction with electro-magnetic energy. For example, a plasmon-responsive element can be a plasmon-assisted optically reflective and/or refractive element, an electrochromic or other optically active element. A plasmon-responsive element may provide or be employed in a detector or sensor for detecting/sensing electromagnetic radiation and/or electric charge, an amplifier or attenuator for amplifying or attenuating electromagnetic radiation and/or electric charge, a modulator for modulating electromagnetic radiation and/or electric charge, a filter, polarizer, resonator, interferometer or polarization rotator for filtering or polarizing electromagnetic radiation or providing electromagnetic radiation of a predetermined polarization, a laser for emitting electromagnetic radiation, a rectifying element for converting plasmons generated by electromagnetic radiation into direct current (DC) voltage, DC current or both, a photovoltaic element, or another element, for example.

As used herein, the term “spectrum” refers to a distribution of elements from a plurality of elements such as particles, quasi particles, excitations or other entities over a predetermined range of an aspect or characteristic associated with each of the elements such as an energy, frequency or wavelength, for example. The term spectrum may refer to a statistical or probability distribution of particles by energy of each of the particles or by interval of energies associated with the particles.

As used herein, the terms “broadband” or “broad band” or the term “broad” with reference to a spectrum or a spectral aspect, refers to one or more wide portions of a spectrum of frequencies, energies or wavelengths, wherein a portion may be contiguous or non-contiguous. For example, in some embodiments broadband may be used to define a spectrum or spectral asset that spans or ranges at least 25 nm or at least 50 nm or at least 100 nm or at least 200 nm or the like.

As used herein, the term “electromagnetic radiation” refers to photons within one or more broad or narrow bands within about 10¹⁰ Hz corresponding to about 0.05 meV to about 10¹⁶ Hz corresponding to about 50 eV.

As used herein, the term “plasmon”, depending on the context, may include the term surface plasmon polariton (SPP) and/or localized surface plasmon resonance (LSPR).

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

An apparatus according to aspects of the present invention is configured to manipulate plasmons. The apparatus comprises a support structure and two or more plasmon-responsive elements. The plasmon-responsive elements are disposed adjacent the support structure. The plasmon-responsive elements are configured for interaction with electromagnetic radiation and generation of plasmons. At least one of the plasmon-responsive elements is configured to manipulate interaction of at least some of the plurality of plasmons with at least another of the plasmon-responsive elements. For example, the plasmon-responsive elements may mutually affect their interaction with plasmons. Depending on the embodiment, the support structure and/or the plasmon-responsive elements are configured to generate plasmons upon exposure to electromagnetic radiation. Depending on the embodiment, the support structure may comprise a plasmon-guide layer for guiding plasmons and/or to at least partially confine plasmons in one or more directions. According to some embodiments, the plasmon-responsive elements are part of the support structure. According to some embodiments, the plasmon-responsive elements form the support structure.

According to embodiments of the present invention, the two or more plasmon-responsive elements configured as nanoscale structures with a nanoscale spacing therebetween and the secondary layer forms an interface with the two or more plasmon-responsive elements such that this interface is proximate to the location of generation of the plurality of plasmons, thereby substantially minimizing attenuation losses of excited charge carriers.

According to embodiments of the present invention, one or more of the plasmon-responsive elements can, in addition to manipulating the interaction of plasmons with the other plasmon-responsive elements, facilitate the ability of plasmon-responsive elements to generate plasmons. Depending on the embodiment, the plasmon-responsive elements can be integrally formed with or defined by the support structure and/or disposed on or adjacent one or more interfaces of the support structure.

The plasmon-responsive elements are configured to manipulate plasmons within one or more predetermined energy and/or wavelength spectral ranges, for example within a broad range, a narrow range or a predetermined number of narrow and/or broad ranges. This ability may extend to plasmons generated by the plasmon-responsive elements and/or plasmons generated by the support structure. Plasmon-responsive elements may be disposed and configured to manipulate plasmons by affecting the concentration of plasmons in other plasmon-responsive elements and/or in the support structure. The manipulation may increase or decrease in part or as a whole or combination thereof electromagnetic radiation in the plasmon-responsive elements and/or the support structure in a predetermined manner determined based on the application.

According to embodiments of the present invention, the support structure and/or the plasmon-responsive elements is/are configured to generate a plurality of plasmons having a plasmon-energy spectrum that is representative of the electromagnetic energy spectrum of the electromagnetic radiation impinging on the apparatus. Depending on the embodiment, the plasmon-energy spectrum may substantially correspond with one or more portions, the entire or substantially the entire electromagnetic energy spectrum of the incoming electromagnetic radiation. Differences in the two spectra, if any, may arise from conversion of portions of the electromagnetic radiation to excitations other than plasmons in the support structure or from lack of interaction of those portions of the spectrum with the support structure, for example.

According to some embodiments of the present invention, the plasmon energy spectrum of converted plasmons corresponds with the plasmon energy spectrum of the plasmons generated by the support structure. According to some embodiments of the present invention, the plasmon energy spectrum of the converted plasmons corresponds with one or more portions of the plasmon energy spectrum of the plasmons generated by the support structure.

According to some embodiments of the present invention, the support structure can be configured as, or comprise, a plasmon-guide layer, wherein plasmons guided to the plasmon-responsive elements can arise from excitations of the plasmon-guide layer and/or other portions of the apparatus and may include plasmons originating from within or outside the plasmon-guide layer. According to embodiments of the present invention, a plasmon-guide layer is configured to direct or retain at least a portion of the plasmons towards or proximate the plasmon-responsive elements.

An apparatus according to embodiments of the present invention can be employed as or in a laser, amplifier, attenuator, modulator, sensor, detector, emitter, filter, photon processing device for optical data processing, polarizer or other device and may be configured as a waveguide or other electrical and/or optical device that supports, enhances, attenuates and/or confines certain modes of electromagnetic radiation. According to some embodiments, an apparatus is employed as or in a device for solar energy conversion and may be configured to concentrate electromagnetic radiation in the plasmon-responsive elements configured as a rectifying element.

In some embodiments, the plasmon-responsive elements are employed for an application such as solar energy harvesting or other application and may be configured to convert at least a portion of the plasmons captured thereby into DC voltage and/or current irrespective of the energy of the captured plasmons such that the energy spectrum of the converted plasmons is representative of the plasmon energy spectrum of the plasmons generated by the apparatus. Embodiments of the present invention that are employed for solar energy harvesting, for example, may be configured to convert the electromagnetic energy with or without electrical bias of the plasmon-responsive elements.

According to embodiments of the present invention, the apparatus is configured for use as a photovoltaic device, wherein the apparatus is configured with nanoscale structures configured as plasmon responsive elements at the interface between the metal layer and the secondary layer. The nanoscale of these interface structures is configured, for example based on size and period of the structure, to facilitate free space coupling of light, for example absorption of the light, without the requirement of a semiconducting absorbing material as is typically the case with current photovoltaic devices. According to embodiments, there is provided a method to efficiently absorb large and controllable portions of the solar spectrum required for efficient electrical energy conversion from solar radiation. The method effectively increases the available portions of the solar spectrum that can be converted to electrical energy, wherein the absorption properties of apparatuses according to the present invention are at least in part controlled by appropriate texturing of the plasmonic interface, for example the sizing and spacing of the nanoscale plasmon responsive elements.

According to embodiments of the present invention, the apparatus is configured such that plasmonic excitation as a result of incident electromagnetic radiation, is localized at the rectifying junction, namely the interface between the metal and the second layer, namely where the plasmon responsive elements are positioned. For example, the apparatus is configured such that the generation of excited charge carriers, for example hot electrons, occurs at the rectifying interface, thereby substantially minimizing the attenuation losses of excited carriers that may occur due to electron-electron and electron-phonon scattering or through interaction with trap/defect sites upon generation of the plasmons thereby aiding in the optimization of the photoemission yield, namely the conversion of photons into an electrical charge. According to embodiments, advantages of localizing the plasmonic excitation, namely generation, at the rectifying interface can be identified by the evaluation of photovoltaic devices designed in evanescent wave configuration, wherein the efficient conversion of incident light to electrical power is demonstrated. However, while devices in this evanescent wave configuration can be constructed to demonstrate this photovoltaic effect at different wavelengths, this configuration of the apparatus according to embodiments of the present invention does not allow the simultaneous conversion of a broad range of the solar spectrum to electrical energy.

According to embodiments of the present invention, good internal quantum efficiency (IQE) can be based on the generation of plasmons at the interface, namely the location of the plasmon responsive elements, the configuration of the diode, namely the layer configuration and area of the interface or the junction. For example, a high surface area at the interface can provide a means for improving the IQE of the apparatus. In addition, the structural shape of the plasmon responsive elements at the interface can also improve the efficiency of the apparatus. For example, efficiency can be enhanced when the plasmon responsive elements have sharp features, for example triangular cross section, conical shapes or the like.

According to embodiments of the present invention, multidimensional nanoscale structured plasmonic apparatuses can provide an improvement in the photovoltaic conversion effect. In order to facilitate improved photoemission response and affect broadband absorption of the solar spectrum simultaneously, the apparatus comprises nanostructured plasmonic materials that constitute plasmon responsive elements configured as rectifying elements. In addition, plasmon responsive elements configured as nanoscale rectifying elements can also provide a benefit through enhancement of the plasmonic field that occurs through excitation of local surface plasmon resonance (LSPR) enhancements and the more localized nature of the LSPR decay compared to planar plasmonic structures. Both effects can aid in the enhancement of the yield of charge carriers, and thus enhance the photovoltaic effect, namely the conversion of solar radiation into electrical power.

An apparatus according to some embodiments of the present invention is configured to employ materials other than semiconductor materials, little semiconductor materials, little or no crystalline semiconductor material, little or no substantially mono-crystalline semiconductor material, little or no substantially polycrystalline semiconductor material, little or no amorphous semiconductor material.

An apparatus according to embodiments of the present invention is configured to provide a predetermined coupling with electromagnetic radiation impinging on the apparatus. For this purpose, and depending on the embodiment, the apparatus comprises adequately configured plasmon-responsive elements and/or an adequately configured support structure, for example, plasmon-responsive elements that provide a textured interface to the support structure or an otherwise configured support structure and plasmon-responsive elements, or an electromagnetic coupling system. Depending on the embodiment, an electromagnetic coupling system can be configured for coupling predetermined amounts of predetermined portions of electromagnetic radiation. An electromagnetic coupling system can include one or more light refracting elements, for example, prisms or other scattering elements such as suitably sized and/or spaced particles, for aiding in coupling the light into the apparatus. It is noted that characteristic features of the electromagnetic coupling system may be determined by the range(s) of wavelengths/energies of the electromagnetic radiation that is/are of interest for the coupling into an apparatus according to embodiments of the present invention, and may be configured to provide a predetermined coupling for visible and/or near visible light.

According to embodiments of the present invention, the apparatus further includes a trapping mechanism, which is configured to contain the electromagnetic radiation impinging on the apparatus but not absorbed or coupled to the plasmon responsive elements. The trapping mechanism provides for the containment of the electromagnetic radiation, for secondary, tertiary and the like interaction with the plasmon responsive elements of the apparatus for subsequent coupling thereto. Examples of a trapping mechanism can include a total internal reflection (TIR) device, waveguiding device, surface structuring and the like.

In some embodiments, the trapping mechanism can be configured as a plasmon guide layer which is operatively coupled to the apparatus. A plasmon guide layer can provide a means for guiding plasmons and/or to at least partially confine plasmons in one or more directions. The plasmon guide layer may further provide a means for the generation of one or more plasmons, for example surface plasmon polaritons (SPP), upon interaction with electromagnetic radiation. The plasmon guide layer can subsequently provide a means for the interaction of the plasmons generated and/or guided thereby, with the two or more plasmon-responsive elements for subsequent manipulation thereby.

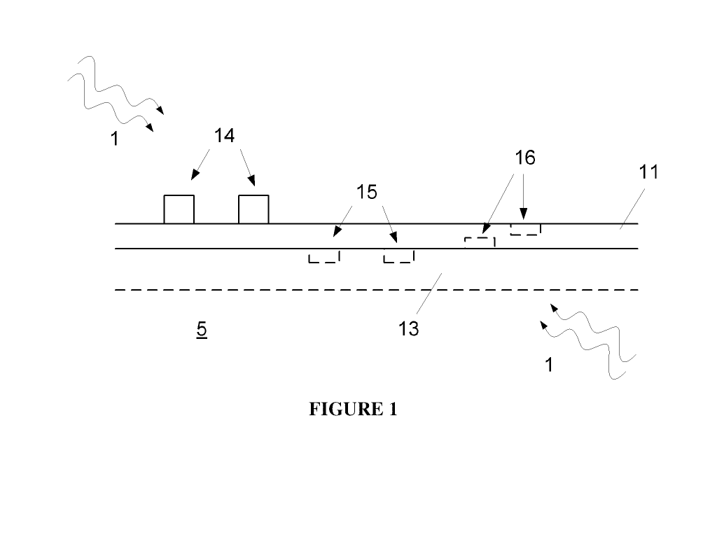

FIG. 1 illustrates a sectional view of an apparatus 5 according to embodiments of the present invention. The apparatus 5 comprises a planar configured support structure 11, which may be disposed on an optional substrate 13. Light 1 can impinge from one or more sides of the apparatus 5. The apparatus 5 includes at least two plasmon-responsive elements. Three example combinations of two plasmon-responsive elements 14, 15, or 16 are illustrated in FIG. 1. Plasmon-responsive elements 14 and 15 are configured as protruding particles and are respectively disposed on top or at the bottom of the support structure 11. Plasmon-responsive elements 16 are configured as indentations of the support structure 11 on both interfaces of the support structure 11. Depending on the embodiment, plasmon-responsive elements may be configured as protruding particles, as indentations, as integrally formed protrusions, or as a combination thereof. Hence apparatus according to embodiments of the present invention may further include combinations of two or more plasmon-responsive elements other then 14, 15 and 16.

Depending on the embodiment, the plasmon-responsive elements 14 and/or 15 or otherwise configured plasmon-responsive elements, may be configured as integrally shaped portions of the support structure 11 or additionally disposed particles. Plasmon-responsive elements may be disposed at or distal from (not illustrated) one or more interfaces of the support structure. The distance between distal plasmon-responsive elements and a proximate interface of the support structure may range from substantially zero to several nanometers or more, for example. Additionally disposed particles may be of the same, substantially similar or distinct composition than the composition of the support structure 11. According to some embodiments of the present invention, the support structure is configured as a metallic material, whereas the substrate 13, if any, or the ambient medium are configured as dielectric/insulating substances.

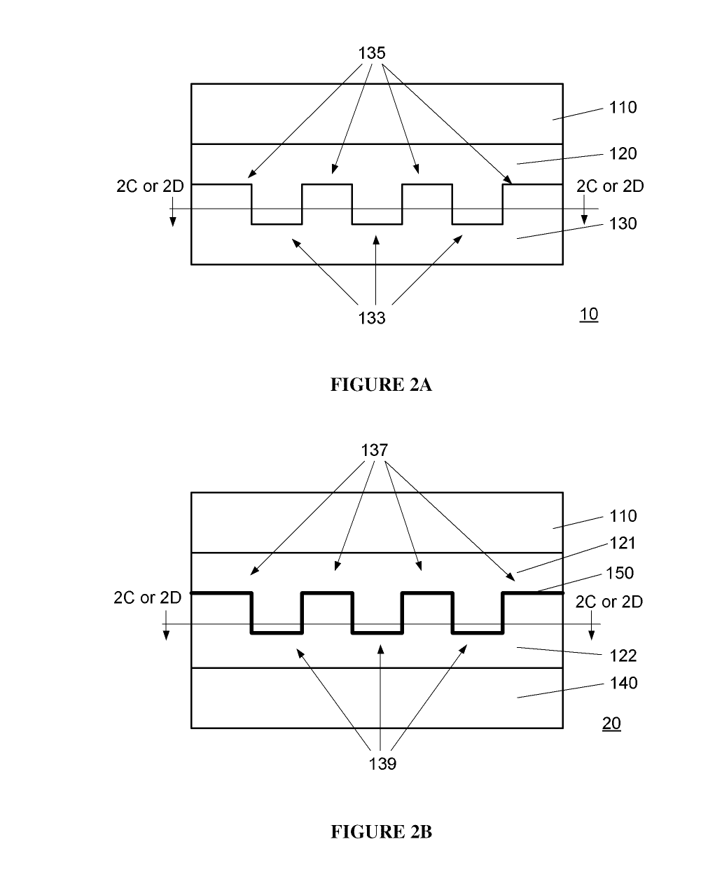

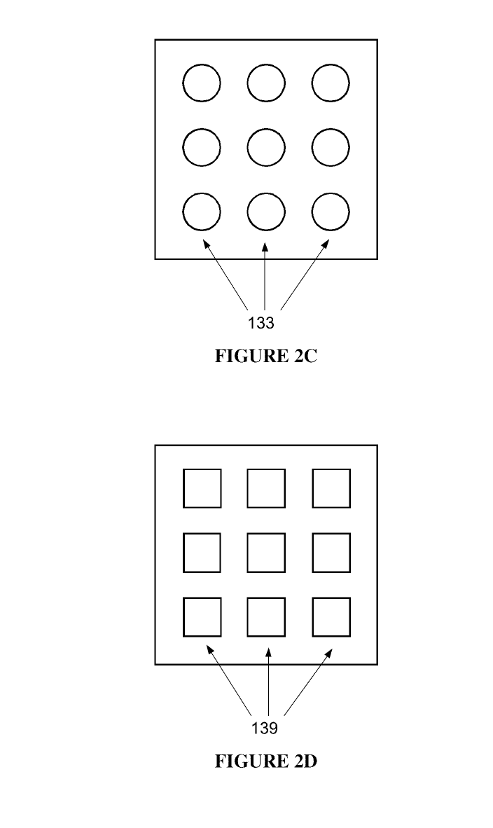

FIG. 2A illustrates a sectional view of an apparatus 10 according to embodiments of the present invention. The apparatus 10 comprises a support structure 130, a dielectric layer 120 and a transparent conducting layer 110. The interface between the support structure 130 and the dielectric layer 120 is configured to define plasmon-responsive elements 135, which are separated by cavities 133 into which the dielectric layer 120 extends. The support structure 130 and the plasmon-responsive elements 135 are operatively coupled, for example, by depositing or integrally forming the plasmon-responsive elements 135 on the support structure 110. The support structure 130 and/or the transparent conducting layer 110 may be configured as substantially flat panels with predetermined thicknesses and predetermined lateral extensions.

FIG. 2B illustrates a sectional view of an apparatus 20 according to embodiments of the present invention. The apparatus 20 comprises a support structure 150 embedded between dielectric layers 121 and 122, which may be referred to as a double-barrier, a transparent conducting layer 110, and a reflective layer 140. The plasmon-responsive elements 137 are defined by the support structure 150. The support structure 150 and the plasmon-responsive elements 137 are integrally formed. The transparent conducting layer 110 and the reflective layer 140 may be configured as substantially flat panels with predetermined thicknesses and predetermined lateral extensions. The transparent conducting layer 110 and the reflective layer 140 may comprise a metal, metal alloy or metal oxide, for example.

FIG. 2C and FIG. 2D illustrate sectional views of the apparatuses 10 and 20 as indicated in FIG. 2A and FIG. 2B. As illustrated the cavities 133 and 139 may have a circular or rectangular cross section and be substantially shaped equal. Depending on the embodiment the cavities may be configured to provide other cross sectional shapes and/or have varying cross sectional shapes and sizes within the same apparatus. Furthermore, plasmon-responsive elements 135 and/or 137 may be inverted with respect to the respective cavities 133 and 139. As illustrated, the plasmon-responsive elements can be positioned in a mesh type configuration.

Depending on the embodiment, the plasmon-responsive elements may be of substantially equal or varying shape, width, length, height, and/or spaced substantially equal or in a varying manner. For example, plasmon-responsive elements and/or cavities may have prismatic, cylindrical, pyramidal, spherical, ellipsoidal, bowtie, fractal, bullseye, spiral conical, or other shaped cross sections or any combination thereof. The dimensions of the plasmon-responsive elements may range from multiples to fractions of the wavelengths of the radiation to which they are exposed. In some embodiments, varying shape, width, length, height, and relative dispositions can be chosen to optimize interactions with electromagnetic radiation and effect the desired functionality of the apparatus.

According to embodiments, the two or more plasmon-responsive elements are configured into a planar pattern, or array. In some embodiments, this planar pattern of plasmon-responsive elements can have one or more axes of symmetry. In some embodiments, the planar pattern of plasmon-responsive elements can have a square type symmetry, a hexagonal type symmetry or a higher dimensional symmetry.

In some embodiments, the planar pattern has an x-direction and a y-direction, wherein the plasmon-responsive elements are spaced apart at a first spacing in the x-direction and a second spacing in the y-direction. In some embodiments, the first spacing and the second spacing are the same and in some embodiments, the first spacing and the second spacing are different. In addition, in some embodiments, the first spacing and/or the second spacing vary along the respective direction.

In some embodiments, the apparatus may be deposited on a substrate (not illustrated), which may be substantially flat or may be configured to provide a curved or segmented interface with the apparatus. The substrate and/or the apparatus may be rigid or may be configured to be flexible and/or plastically deformable under predetermined forces, for example. Apparatuses according to embodiments of the present invention may be configured to remain substantially operable under corresponding predetermined deformations. Apparatuses may be overcoated with predetermined material, for example, with a substance that protects the apparatus from predetermined environmental conditions and/or a substance that facilitates transmission and/or retention of light and/or electromagnetic radiation. For example, the substance may comprise a crystalline, polycrystalline or amorphous material such as a glass, transparent metal or metal oxide, an organic or inorganic plastic or other material. The thickness of the substance may be determined by optical and/or mechanical properties of the substance and may range from one or more atomic layers, to nano- or micrometers to millimeters or more, for example.

According to embodiments of the present invention an apparatus is configured to be operative upon exposure to light and/or electromagnetic radiation from the top and/or the bottom of the apparatus. Embodiments of the apparatus that include a substrate may be configured so that the substrate provides a predetermined transparency to electromagnetic radiation, for example, in order to suppress or facilitate transmission of electromagnetic radiation through the substrate that may impinge on the apparatus from the bottom.

According to embodiments of the present invention the apparatus is electrically connected to provide electrical voltage and/or current generated thereby. According to embodiments of the present invention and according to FIGS. 2A and 2B, a first electrical connection is provided directly via the support structure 130 or 150, the transparent conducting layer 110, the reflective layer 140 and/or the substrate. According to embodiments, the apparatus comprises one or more additional first contact pads (not illustrated). The contact pads may be electrically connected to the support structure 130 or 150 and/or the substrate to provide an electrical connection. Furthermore, a second electrical connection may be provided directly via the transparent conducting layer 110 or the reflective layer 140, for example.

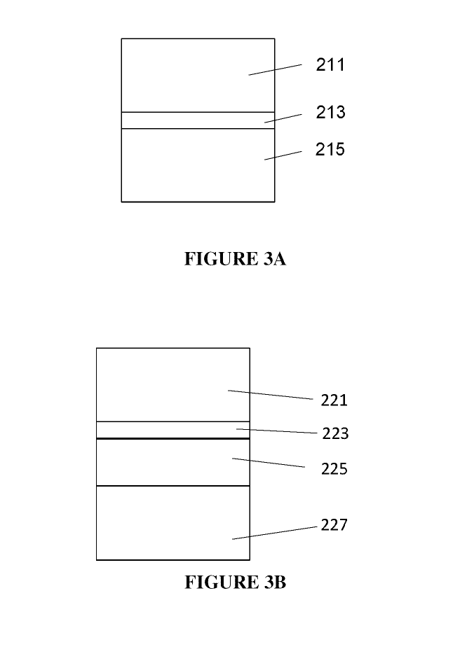

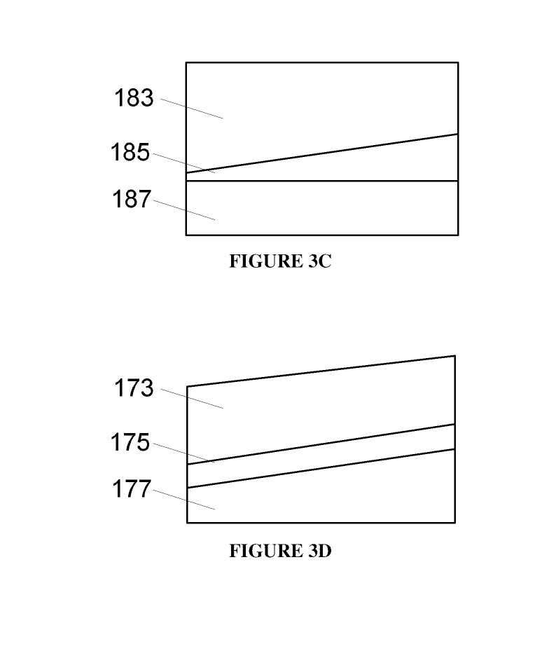

FIGS. 3A to 3D illustrate sectional views of apparatuses according to embodiments of the present invention. The apparatuses comprise multilayer junctions including plasmon-responsive elements (not illustrated in FIGS. 3A to 3D) which may be disposed at certain interfaces, for example, a metal interface, of the respective apparatuses. The plasmon-responsive elements may be disposed within the apparatus at locations as further described herein. Each layer of each multilayer junction may be configured as a metallic, semi-metallic, semiconducting or insulating layer. The multilayer junctions may be configured as metal-insulator-metal (MIM), metal-semiconductor, semiconductor-semiconductor, insulator-semiconductor or other junction, for example. It is noted that apparatuses according to other embodiments may comprise a greater or lesser number of layers than illustrated. Depending on the embodiment, an apparatus according to the present invention may comprise materials other than semiconductor material.

An example of a multilayer junction is illustrated in FIG. 3A and includes layer 211, layer 213 and layer 215. Depending on the embodiment, the plasmon-responsive elements may be disposed at one or more of the interfaces between layers 211 and 213 or between layers 213 and 215. Depending on the embodiment, the support structure may comprise layer 211 and/or layer 215. Depending on the embodiment, layers 211, 213 and 215 may be metallic, semiconducting or insulating. The layers may be formed by dry or wet chemical deposition, self assembly, deposition of a corresponding oxide, nitride or other dielectric material or by oxidizing or nitriding a top portion of a previously deposited metal or other material layer of which the remaining portion may be used to form a subsequently deposited layer, for example.

Another example multilayer junction is illustrated in FIG. 3B and includes layer 221, layer 223, layer 225, and layer 227. Depending on the embodiment, the plasmon-responsive elements may be disposed at one or more of the interfaces between layers 221 and 223, between layers 223 and 225 and/or between layers 225 and 227. Depending on the embodiment, the support structure may comprise one or more of layer 221, layer 225 and/or layer 227, for example. Depending on the embodiment, layers 221, 223 and 225 may be metallic, insulating or a semiconducting, for example. The layers may be formed by dry or wet chemical deposition, self assembly, deposition of a corresponding oxide, nitride or other dielectric material or by oxidizing or nitriding a top portion of a previously deposited metal or other material layer of which the remaining portion may be used to form a subsequent deposited layer, for example.

FIG. 3C and FIG. 3D illustrate sectional views of plasmon-responsive elements with multilayer junctions formed by one or more oblique interfaces. The multilayer junction of FIG. 3D comprises layer 183, wedge shaped layer 185 and layer 187. The junction of FIG. 3D comprises layer 173, layer 175 and a wedge shaped layer 177. According to embodiments, plasmon-responsive elements with wedge-shaped layers and/or oblique interfaces can be employed with more than one junction. Each layer of each multilayer junction may be configured as a metallic, semi-metallic, semiconducting or insulating layer.

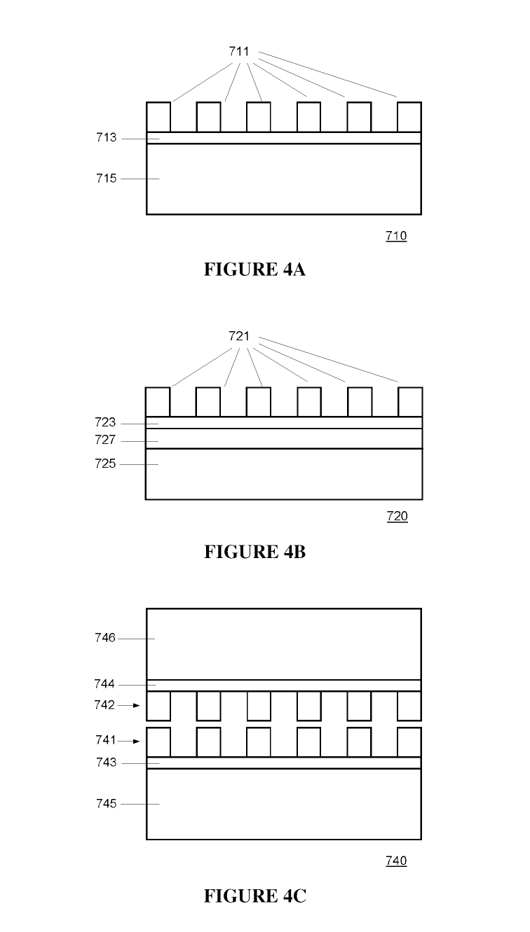

FIG. 4A, FIG. 4B and FIG. 4C illustrate sectional views of different configurations of apparatuses according to embodiments of the present invention. Apparatuses 710, 720 and 740 comprise respective plasmon-responsive elements 711, 721, 741 and 742 disposed in combination with different multilayer junctions. Apparatuses 710, 720 or 740 may comprise further layers (not illustrated), which may be disposed, for example, over top of the plasmon-responsive elements 711 and 721 or in between plasmon-responsive elements 741 and 742. The multilayer junction of apparatus 710 comprises layer 713 and layer 715. The multilayer junction of apparatus 720 comprises layers 723, 725 and 727. The multilayer junction of apparatus 740 comprises layers 741, 743, 745, 742, 744 and 746. Each of layers 713, 715, 723, 725, 727, 741, 743, 745, 742, 744 and 746 may be configured as a metallic, semi-metallic, semiconducting or insulating layer, the selection of which can be determined based on the intended use of the respective apparatus. In addition, the plasmon-responsive elements 711, 721, 741 and 742 may be configured as further described herein.

According to some embodiments of the present invention, the apparatus is configured with semiconductor materials which are layered. The material layering is chosen such that the desired combination of optical coupling between the impinging light and the plasmon-responsive elements, charge carrier transport within the semiconductor materials, and a suitable barrier for rectification is provided. For example, TiO₂ has a bulk electron mobility of 1 cm²/Vs, an index of refraction between 2.4 and 2.9 in the visible and forms effective Schottky barriers with a number of metals; while ZnO has a bulk electron mobility of 200 cm²/Vs, an index of refraction of refraction between 1.9 and 2.0 in the visible and may form an effective Schottky barrier with a different set of metals. Since the conduction band level of these two materials are nominally aligned, they may be layered to obtain the desired absorption, rectification and charge transport properties for a given metal.

According to embodiments of the present invention, the apparatus is configured in order to substantially maximize the conversion of plasmons to electrical energy via internal emission. In some embodiments, after a surface plasmon is generated near a metal-semiconductor interface, namely the interface where the plasmon responsive elements are positioned, the plasmon may be involved in an internal emission process. The efficiency of this internal emission process can be enhanced by increasing the surface area of the rectifying junction immediately in the vicinity of the plasmon generating element. Namely, the interface which supports surface plasmon generation can be a rectifying interface, and the interface can be configured such that the attenuation of excited carriers, for example hot electrons, is minimized.

According to embodiments, barrier or interface optimization of the apparatus can be enabled through the appropriate configuration of the interface. For example, the internal emission process is strongly governed by the metal-semiconductor junction barrier or interface. For a given material set, the substantially optimal barrier height may be adjusted via the introduction of interface dipoles.

According to embodiments, the concentration of plasmonic energy into a small volume at the metal-semiconductor junction or interface, can yield very high electric field intensities, which can also serve to enhance multi-plasmon effects as well as direct transitions from the metal to the semiconductor.

### Support Structure

The support structure facilitates the disposition of the plasmon-responsive elements and comprises adequate material for this purpose. Depending on the embodiment, the support structure may further guide and/or generate plasmons upon exposure to electromagnetic radiation and may be geometrically configured for same. For this purpose and depending on the embodiment, the support structure may comprise a plasmon-guide layer. Plasmons guided by the support structure can be characterized by a first plasmon energy spectrum representative of the electromagnetic energy spectrum of the electromagnetic radiation.

According to some embodiments of the present invention, the support structure is configured to generate and guide plasmons and confine the plasmons within or adjacent the support structure. The support structure may be configured to provide a predetermined localization and/or extension of plasmons perpendicular to and/or within and/or adjacent the support structure. For this purpose, the support structure may comprise one or more layers of materials with predetermined characteristics including dielectric properties, predetermined constant or varying concentration, thickness, interface roughness and/or texture, and/or other characteristics that, alone or in combination, provide a predetermined electromagnetic radiation to plasmon conversion efficiency, and an electrical and/or optical confinement for the plasmons and/or the electromagnetic radiation. For example, each layer may be characterized by a predetermined relative dielectric constant at a predetermined frequency. Depending on the embodiment, the relative dielectric constant of a layer may be selected to vary within a substantially low or high range. For example, a low relative dielectric constant may be substantially one, and a high relative dielectric constant may be within the range of one to ten or several orders of magnitude higher, depending on the frequency.

According to embodiments of the present invention, one or more interfaces of the support structure may be textured. Depending on the embodiment, an interface of the support structure may be embossed, etched, and/or formed by spontaneous self-alignment of host material used to form the support structure during deposition and/or formed by deposition of impartial interface layers of host material or different material. It is noted that one or more of these processes may be employed also for the formation of one or more of the plasmon-responsive elements.

According to some embodiments of the present invention, the support structure is configured to convert a predetermined portion of impinging electromagnetic radiation selectively, for certain wavelengths/energies, or collectively, irrespective of the wavelength/energy of the impinging photons. The support structure can be configured to convert a predetermined portion of the electromagnetic radiation into plasmons having corresponding energies. According to some embodiments of the present invention, the support structure is configured to convert substantially all impinging electromagnetic radiation within one or more wavelength/energy ranges into plasmons. Such ranges may include infrared light, ultraviolet light, visible light, near visible infrared light, near visible ultraviolet light, or a combination of one or more portions thereof.

According to some embodiments, the support structure is configured to generate one or more plasmons upon absorption of one or more photons. For example, the support structure may be configured to generate one plasmon upon absorption of one photon, two or more plasmons upon absorption of one photon, or one plasmon upon absorption of two or more photons, or facilitate other combinations of multi-particle conversions and/or excitations. The generation of plasmons may be facilitated by absorption of or by generation of additional quasiparticles in or adjacent the support structure, for example, by absorption or generation of one or more phonons or other quasiparticles/excitations.

The support structure may comprise one or more elemental or compound materials including conductive or semiconductive material, one or more metals such as Al, Au, Ni, Cr, Pt, Cd, Ag, Cu, etc, metal oxides, metal alloys or other material. According to embodiments of the present invention, the support structure includes materials other than semiconductor materials. According to some embodiments of the present invention, the support structure includes only materials other than semiconductor materials. The support structure may comprise a medium useful for generating and guiding plasmons. The support structure may comprise one or more layers of one or more predetermined thicknesses each comprising one or more materials. The thickness of each of the one or more layers may depend on one or more properties thereof and/or the thickness and/or properties of one or more adjacent layers of the support structure or other element. For example, the support structure may have a thickness in the range of one or more atomic layers, one or more nanometers, one or more micrometers, one or more millimetres or thicker.

According to some embodiments of the present invention, the support structure comprises one or more layers with planar, curved or other interfaces. The interfaces may be flat, textured, plan-parallel, wedged or oblique with respect to one another. Each interface may be parallel, oblique or perpendicular as a whole or in part with respect to another interface of the support structure or an interface with another layer and/or component. The size of the support structure and/or the thickness of one or more layers in the support structure may be uniform or vary within a predetermined size/thickness range depending on the position within the support structure. For example, the size of the support structure or the thickness of a layer thereof range within one or more atomic layers, one or more nanometers, one or more micrometers greater.

According to an embodiment of the present invention, the support structure and/or one or more of the layers included in the support structure may have uniform compositions, may be crystalline, polycrystalline, amorphous, may have a glass-like or other composition. In some embodiments, the support structure includes therein a predetermined number of dislocations, crystal defects and/or impurities of other materials.

In some embodiments of the present invention, the support structure is configured in a mesh type configuration. For example, the mesh type configuration can be formed from a plurality of conductive leads which provide for electrical contact with the plasmon-responsive elements of the apparatus.

### Plasmon-Responsive Elements

Plasmon-responsive elements are configured to facilitate one or more of generation, manipulation and/or conversion of plasmons, in response to exposure to electromagnetic radiation and/or plasmons. Plasmon-responsive elements may be categorized into different types based on the function they can perform. Depending on the embodiment, a single plasmon-responsive element may be configured to perform one or more of generation, manipulation and/or conversion of plasmons. A single type of plasmon-responsive elements or different types of plasmon-responsive elements may be included in an apparatus according to embodiments of the present invention. Different plasmon-responsive elements within an apparatus can have different sizes, shapes and/or compositions or the like. An apparatus according to embodiments of the present invention can comprise one or more types of plasmon-responsive elements.

In some embodiments, the plasmon-responsive elements are configured to at least manipulate plasmons with predetermined plasmon-energies. Depending on the embodiment, plasmon-responsive elements may manipulate plasmons within one or more portions or all of 0.4 eV to 3.5 eV or within other energy ranges, for example. According to embodiments of the present invention, the plasmon-responsive elements are configured to manipulate plasmons within one or more predetermined bands of plasmon energies. Depending on the embodiment, the plasmon-responsive elements may be disposed adjacent and/or proximate the support structure for operative disposition.

According to some embodiments of the present invention the plasmon-responsive elements comprise a multilayer junction including one or more junctions, wherein a junction can be metal-insulator, metal-semiconductor, semiconductor-semiconductor and/or semiconductor-insulator or other junction format. According to some embodiments, the plasmon-responsive elements form a multilayer junction in combination with other plasmon-responsive elements and/or the support structure. Each junction may include insulating/dielectric, metallic, semi-metallic and/or semiconducting material, which may be organic or inorganic or both. The one or more junctions may be provided by one or more interfaces between two or more layers of predetermined thickness and composition. Interfaces defined by a junction may be parallel, perpendicular or oblique with respect to one another and the interfaces may be parallel, normal or oblique with respect to the support structure.

Depending on the embodiment, multilayer junctions formed by or included in plasmon-responsive elements may further provide a rectifying function for rectifying charge carriers that may be generated in the corresponding apparatus. In accordance with some embodiments and as further described herein, plasmon-responsive elements may facilitate the generation of such charge carriers. In accordance with some embodiments, both rectifying as well as non-rectifying plasmon-responsive elements can be included in an apparatus.

With respect to FIG. 4C it is noted that the apparatus 740 can be configured so that the combination of the plasmon-responsive element 741 and 742, which are oppositely disposed with respect to each other, provide a rectifying function across the gap between proximate pairs of plasmon-responsive elements 741 and 742. For this purpose, the gap may comprise vacuum, air, a dielectric, insulating or semiconducting material or other suitable material, for example.

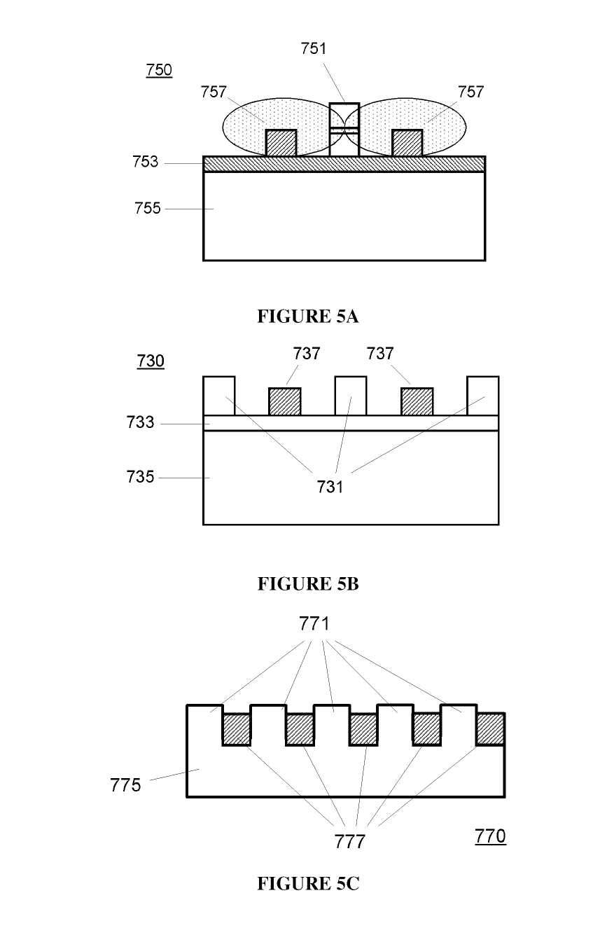

FIG. 5A illustrates a sectional view of an apparatus 750 according to some embodiments of the present invention. The apparatus 750 includes different types of plasmon-responsive elements 751 and 757, respectively. The plasmon-responsive elements 757 are configured to facilitate generation of substantially localized plasmons (as indicated by ellipses in FIG. 5A). The plasmon-responsive element 751 comprises a multilayer junction that is configured for rectifying plasmons. Depending on the embodiment, the plasmon-responsive element 751 may further be configured to aid in generating plasmons. The apparatus 750 further comprises layer 753 and layer 755, which each can comprise metallic, semi-metallic, semiconducting and/or insulating material, for example.

According to an embodiment of the present invention, the one or more junctions are configured to provide adequate lateral and perpendicular extensions to support the speed at which plasmons within the desired energy range are intended to be generated and/or manipulated. The generation and/or manipulation may include aspects of rectification, optical stimulation, attenuation and/or amplification. Depending on the embodiment, the plasmon-responsive element may comprise junctions with small predetermined lateral extensions.

According to embodiments of the present invention, the plasmon-responsive elements are configured to interact with plasmons in a predetermined manner. Depending on the embodiment, the dimensions of plasmon-responsive elements within an apparatus may vary. The plasmon-responsive elements may comprise a substantially prismatic body with a regular or irregular, or a circular, triangular, quadratic, or otherwise shaped base. According to an embodiment of the present invention, the plasmon-responsive elements are configured to manipulate plasmons and have at least one component that has a thickness or size that is about several hundred nm or less.

According to embodiments of the present invention, the plasmon-responsive elements comprise one or more different materials, for example different elemental or compound material including conductive or semiconducting, organic or inorganic material including elemental, binary, ternary, quaternary or other compound and/or direct or indirect gap and/or magnetic or non-magnetic semiconductors such as GaAs, Si, C, CdTe, PbTe, PbS, one or more metals such as Al, Au, Ni, Cr, Pt, Cd, Ag, Cu, etc, metal oxides such as TiO₂, ZnO or other, metal alloys, organic, metalorganic, non-metal organic such as polyimide or other material, for example. Depending on the embodiment, plasmon-responsive elements may comprise reactive and/or non-reactive dye molecules, which may be configured to provide one or more certain functions, for example generation, manipulation and/or conversion of plasmons and/or electromagnetic radiation. According to embodiments of the present invention, one or more plasmon-responsive elements include materials other than semiconductor materials. According to some embodiments of the present invention, one or more plasmon-responsive elements include only materials other than semiconductor materials.

With respect to aspects such as thickness and/or composition of layers included in a multilayer junction, a plasmon-responsive element may comprise one or more symmetrical and/or one or more asymmetrical junctions or a combination thereof. For example, a symmetrical junction may comprise a first layer of Ni of a predetermined thickness separated from another Ni layer of the same or different thickness by a NiO layer or another symmetrical combination of materials. An example of an asymmetrical junction may comprise a Ni layer that is separated by a NiO layer from an Au layer or another asymmetrical combination of materials.

The plasmon-responsive elements are operatively disposed with respect to and/or operatively connected to the support structure. For this purpose, the plasmon-responsive elements may be integrally formed with the support structure or may include material that facilitates operative connection, including electrical connection and/or adhesion, to the support structure. The operative coupling may be facilitated by various processes including selective and/or non-selective deposition, masking and/or selective and/or non-selective removal of one or more layers of the one or more materials of the support structure using various processes including liquid or vapour phase deposition, sputtering, epitaxial deposition or other deposition methods, for example. Masking and removal of material may be accomplished by one or more etching steps including plasma, electrochemical, ion, electron or other etching technologies, for example.

According to some embodiments of the present invention, the plasmon-responsive elements are prefabricated before disposition on the support structure. Such a process may be employed to efficiently dispose the plasmon-responsive elements on the support structure. According to embodiments of the present invention, prefabricated plasmon-responsive elements may be configured in combination with a support structure to facilitate self-adherence.

As noted herein, an apparatus according to the present invention comprises one or more plasmon-responsive elements that manipulate interaction of at least some plasmons with one or more other plasmon-responsive elements. According to some embodiments, the plasmon-responsive elements are configured to enhance the generation of and/or operative coupling with plasmons facilitated by one or more of the plasmon-responsive elements and/or the support structure.

The manipulation of plasmons in one of the plasmon-responsive elements, at least in part, depends on the configuration of that element and the configuration of other plasmon-responsive elements. For example, plasmon-responsive element configurations can include at least shape, size and composition of each plasmon-responsive element and their positions relative to each other. Different plasmon-responsive elements in an apparatus according to the present invention can have nominally equal or different configurations. Depending on the embodiment, one or more of the plasmon-responsive elements may, in addition to concentrating plasmons in the plasmon-responsive elements, facilitate the generation of plasmons in the support structure, for example. According to some embodiments of the invention, depending on the configuration of the plasmon-responsive elements, the generation and/or manipulation of the plasmons can facilitate the conversion of electromagnetic energy within one or more predetermined spectral ranges to a substantially DC electrical voltage and/or current by the apparatus.

In order to achieve a predetermined plasmon-manipulating and/or plasmon-generating function of the plasmon-responsive elements, plasmon-responsive elements may be disposed at a predetermined distance from each other. The predetermined distances can be determined based on the application of the embodiment. For example, the predetermined distance may be determined based on the intended type and degree of generation and/or manipulation of plasmons in the plasmon-responsive elements, the rate of the conversion, if any, and the intended result of the conversion, for example, the amount of light and/or charge generated by a converted plasmon or other parameter.

Depending on the embodiment, one or more of the plasmon-responsive elements may be configured as a protrusion, a void or filled depression in the support structure, wherein the plasmon-responsive elements are of predetermined shapes and dimensions. Plasmon-responsive elements may be disposed at, proximal to or distal from one or both interfaces of the support structure. Plasmon-responsive elements that are configured as voids or depressions may be filled with a predetermined material, for example a metal or non-metallic material, a dielectric or insulating material, a semimetal or semiconductor material or other material, for example.

The plasmon-responsive elements may have predetermined heights, widths and lengths. Depending on the embodiment, the heights and at least one of the other two dimensions, for example the widths or lengths, may be of subwavelength size, and one of the width or length may be of the order of a subwavelength, wavelength or larger size, wherein wavelength refers to wavelengths included in the electromagnetic radiation spectrum.

FIG. 5B illustrates a sectional view of an apparatus 730 according to some embodiments of the present invention. The apparatus 730 comprises plasmon-responsive elements 731 and 737 of different height and composition (which is indicated in the figure by the presence or lack of hatching), which are disposed over top of layer 733 and layer 735, one or more of which may act as a support structure. The plasmon-responsive elements 731 and 737, as well as layers 733 and 735 comprise one or more of metallic, semi-metallic, semiconducting and/or insulating material. The apparatus 730 may comprise further layers, disposed over top of the plasmon-responsive elements 731 and 737, for example.

FIG. 5C illustrates a sectional view of an apparatus 770 according to some embodiments of the present invention. The apparatus 770 comprises plasmon-responsive elements 771 and 777 of different height, shape and/or composition. One or more of the plasmon-responsive elements 771 and 777 can be configured as ridges, polyhedra, pillars, prisms and/or can have other shapes as described herein. One or more of the plasmon-responsive elements 771 and/or 777 can have regular and/or irregular shapes, interfaces and/or surfaces, and/or can be spaced at regular and/or irregular distances. The surface of the plasmon-responsive elements 771 and/or 777 can have an irregular morphology. Depending on the embodiment, one or more of the plasmon-responsive elements 777 can be lower and/or one or more of them can be higher (not illustrated) than the plasmon-responsive elements 771. Depending on the embodiment, the plasmon-responsive elements 771 may be integrally formed with layer 775. Layer 775 may act as a support structure. Depending on the embodiment, plasmon-responsive elements can also be non-integrally formed with the below layer. The plasmon-responsive elements 771 and 777, and layer 775 can comprise one or more of metallic, semi-metallic, semiconducting and/or insulating material. The apparatus 770 may comprise further layers, disposed over top of the plasmon-responsive elements 771 and 777, for example.

A plasmon-responsive element, when considered separate from the support structure or when configured as a depression formed at an interface and considered as the depression itself, may have a substantially regular or a substantially irregular shape, for example, a polyhedron, such as a cuboid, prism, cylinder or other polyhedron, or a sphere or partial sphere, a T-sectional shaped body, pyramid, bowtie, fractal, bullseye, spiral or other shape, or combination thereof.

According to embodiments of the present invention, a plasmon-responsive element is formed by deposition of a particle of adequate composition on the support structure, or by forming a depression in the support structure at a predetermined position. A plasmon-responsive element may have a predetermined shape and predetermined dimensions substantially corresponding with the shape and/or dimensions of the particle before deposition, or its shape and size may be defined during or after deposition. According to embodiments of the present invention, formation of respective plasmon-responsive elements may be facilitated by protrusions or other interface elements provided by the support structure and/or the substrate.

Plasmon-responsive elements, whether formed through deposition of material or by forming a protrusion or depression, for example in the support structure, may be formed and operatively coupled to the support structure by various processes including selective and/or non-selective deposition, masking and/or selective and/or non-selective removal of one or more layers of one or more materials or combination thereof, using various processes including liquid or vapour phase deposition, sputtering, epitaxial deposition or other deposition methods or combination thereof, for example. Masking and removal of material may be accomplished by one or more patterning and/or etching steps including plasma, electrochemical, ion, electron beam, lithography, nanoimprint lithography and/or other technologies.

Plasmon-responsive elements may be formed from one or more materials, for example, dielectric/insulating materials including air, metal and/or metal alloys, conductive, semimetallic or semiconducting material, organic or inorganic material including metalorganic material and other material. According to embodiments, plasmon-responsive elements are formed from the same or different material used in the support structure.

### Substrate

An apparatus according to embodiments of the present invention may be disposed on a substrate. According to an embodiment, the substrate may be provided by the support structure. The substrate may provide structural support to the apparatus and/or be employed for operative connection of the apparatus, for example. The substrate may be configured as a rigid or flexible carrier for the apparatus and comprise one or more layers of one or more materials. Depending on the embodiment, the substrate may comprise an amorphous, polycrystalline or crystalline organic or inorganic material or combination thereof. For example, the substrate may comprise a pane of glass, a sheet of a predetermined plastic material, a rigid or elastic wafer of crystalline silicone or other material of predetermined thickness. Depending on the embodiment, the thickness of the substrate may range from submicrometer to micrometers to several millimetres or more, for example.

Depending on the embodiment, the substrate may be configured to provide a substantially constant or variable transparency for all or a portion of electromagnetic radiation. The substrate may have a predetermined transparency exceeding one or more predetermined thresholds at one or more predetermined wavelengths. For example, the substrate may be configured to be more than about 90% transparent to light within about 400 nm to about 1400 nm wavelengths. Depending on the embodiment, the substrate may be configured to provide a transparency that is higher or lower than about 90% or for other wavelength ranges.

In some embodiments, the substrate is configured to facilitate deposition of and operative interconnection with the support structure. The operative connection may be characterized by predetermined mechanical, thermal and/or electrical characteristics. The substrate and the support structure may be operatively interconnected by rolling, gluing, melting, soldering, deposition from a bath, liquid and/or vapour phase deposition, epitaxial deposition or other form of deposition, for example. According to embodiments of the present invention, the substrate and the support structure may be integrally formed.

### Electromagnetic Radiation Coupling System

An apparatus according to embodiments of the present invention optionally comprises an electromagnetic radiation coupling system. The electromagnetic radiation coupling system may be configured to provide a predetermined coupling between electromagnetic radiation impinging on the apparatus and the plasmon-responsive elements and/or the support structure. The electromagnetic radiation coupling system may be disposed proximate or adjacent the support structure.

According to an embodiment of the present invention, the electromagnetic radiation coupling system is configured and disposed so that light impinging on the apparatus from within a predetermined solid angle is substantially redirected and/or optically concentrated in or proximate the plasmon-responsive elements and/or the support structure. The electromagnetic coupling system may be configured for free-space, evanescent wave and/or other coupling with electromagnetic radiation. The electromagnetic coupling system may comprise one or more refractive elements, free-space wave coupling elements, evanescent wave coupling elements, anti-reflection coatings, waveguide structures, surface and/or interface structures, morphologies and/or elements, optical trapping elements, prisms, suitably sized, shaped and/or composed particles, transparent metal oxides and/or other elements, for example. According to embodiments of the present invention, each of the one or more prisms may be disposed relative to the support structure to redirect light from within one or more predetermined solid angles, substantially towards the plasmon-responsive elements and/or the support structure.

According to embodiments of the present invention, the electromagnetic coupling system comprises a plurality of adequately-small sized particles for improving the coupling between impinging electromagnetic radiation and the plasmon-responsive elements and/or the support structure. The particles may be disposed adjacent or proximate the support structure, for example, on a planar support structure or a substrate. The particles may be nano-sized and have one or more predetermined shapes and/or dimensions and comprise one or more dielectric, insulating, semiconducting, semi-insulating, conducting, metallic or non-metallic, elemental or non-elemental, pure or compound/alloy materials and/or various modifications thereof and/or other suitable material. The particles may comprise Al, Au, Ag, Pt, Al, Ni, Si, C, and/or other elements, for example.

### Fabrication Methods

According to embodiments of the present invention, elements or portions of elements of the apparatus may be disposed by a number of thin- or thick-film deposition, structuring and/or material-removal technologies including sputtering, plating, chemical solution deposition, chemical vapour phase deposition, physical vapour phase deposition, laser deposition, arc deposition, molecular beam epitaxy, reactive and/or non-reactive deposition technologies including metal-organic deposition techniques, positive or inverse masking technologies, scribing, plasma etching, ion etching, wet or dry etching or other deposition, structuring and/or material removal technologies or combinations thereof.

The fabrication of nanoscale plasmon-responsive elements typically requires a method to introduce nanoscale texture to the apparatus, for example, at the interface of the support structure. In accordance with embodiments of the present invention, this can be accomplished by introducing texture to a dielectric/insulating layer followed by subsequent deposition of a support structure, or through the introduction of texture to the support structure followed by deposition of an appropriate dielectric/insulating layer or another method, for example. A number of fabrication methods are available which allow the introduction of nanoscale texture, which may be used to fabricate apparatuses according to some embodiments of the present invention. Example methods include, but are not limited to, electron-beam lithography, nanoimprint lithography, nanoparticle deposition and templating methods, sol gel methods, electrodeposition, colloidal and related lithography methods, anodization, interference patterning, solution phase nanocrystal growth, chemical vapor deposition (CVD), physical vapor deposition (PVD), atomic layer deposition (ALD), pulsed laser deposition (PLD), as well as grazing angle deposition methods. Appropriate implementation of these methods by those skilled in the art is expected to result in nanoscale plasmonic interface structures capable of coupling solar energy into localized surface plasmon resonances (LSPRs) for subsequent rectification.

An apparatus according to embodiments of the present invention can be manufactured using materials other than semiconductor materials, little semiconductor materials, little or no crystalline semiconductor material, little or no substantially mono-crystalline semiconductor material, little or no substantially polycrystalline material, little or no amorphous semiconductor material, and/or inexpensive semiconductor material, and corresponding processes.

### Applications

Apparatuses according to embodiments of the present invention may be employed to usefully couple light into electronic devices of subwavelength size. Such electronic devices may include metal-insulator-metal (MIM) structures, which can be used as waveguide structures, confine surface plasmon polariton (SPP) modes and/or significantly affect the electro-magnetic field within the device. Such devices may usefully employ wavelengths ranging from the visible to the near infrared and include optical emitters, plasmon focusing, hybridized plasmonic modes in nanoscale metal shells, nanoscale wave guiding, nanoscale optical antennas, plasmonic integrated circuits, nano scale switches, plasmonic lasers, surface-plasmon-enhanced light-emitting diodes; imaging below the diffraction limit and materials with negative refractive index. Example applications may include solar-energy conversion devices, surface plasmon amplification by stimulated emission of radiation (SPACERS), plasmon-based modulators, interferometers, beam splitters, detectors, subwavelength diffraction gratings to enhance the free-space coupling of light into devices and dielectric slab waveguides as a means to couple light efficiently into waveguides

Apparatuses according to some embodiments of the present invention are configured for photovoltaic applications. With respect to photovoltaic applications, apparatuses according to some embodiments of the present invention can exploit the absorption characteristics of plasmon-responsive elements to allow free space coupling of solar radiation to the plasmon-responsive elements, for example, in order to induce high intensity local fields in their vicinity. Furthermore, the use of plasmon-responsive elements, which may themselves be rectifying, or may provide one or more components of a rectifying element, used to convert alternating plasmonic fields, for example, may be useful to generate electrical energy directly. Moreover, according to some embodiments of the present invention, the plasmon-responsive elements can act as an absorbing layer and as the source of charge carriers that can perform useful electrical work. Specifically, some embodiments of the present invention do not require use of a light-absorbing semiconducting material for this photovoltaic conversion. Certain embodiments therefore provide significant relief to the material requirements placed on other photovoltaic technology and may represent an inexpensive alternative to semiconductor-based photovoltaic devices, thereby offering the potential for large scale deployment of solar energy technology at costs competitive with fossil fuel based energy generation. Distinct from other technologies, some embodiments of the present invention may be employed as a photovoltaic cell which takes advantage of the direct conversion of plasmonic modes into electrical energy while avoiding the losses due to electron-hole recombination. Some embodiments may not require rectifying structures or materials of conventional photovoltaic devices. Embodiments can offer possible utilization of a range of inexpensive materials for their fabrication. Furthermore, plasmon-responsive elements may be provided by textured nanoscale interfaces of the support structure, and can be used for plasmonic coupling of solar radiation and may not be restricted by the limited absorption properties of specific nanoparticle additives, nor the difficulties establishing electrical contact with them.

Apparatuses according to embodiments of the present invention that are configured for photovoltaic applications can be manufactured using and/or include materials other than semiconductor materials, little semiconductor materials, little or no crystalline semiconductor material, little or no su bstantially mono-crystalline semiconductor material, little or no substantially polycrystalline material, little or no amorphous semiconductor material, and/or inexpensive semiconductor material, and corresponding processes.

The invention will now be described with reference to a specific example. It will be understood that the example is intended to describe aspects of some embodiments of the invention and is not intended to limit the invention in any way.

### EXAMPLES

### Example I

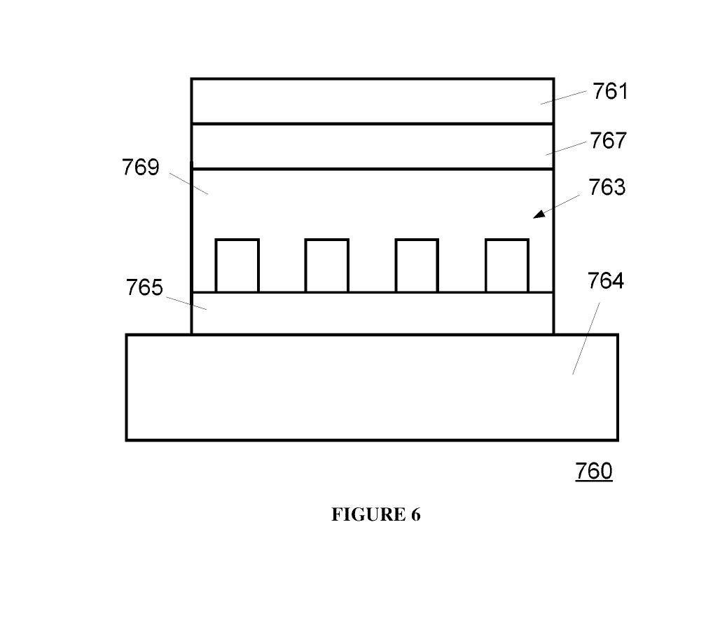

FIG. 6 illustrates a sectional view of an example apparatus 760 according to some embodiments of the present invention. The apparatus 760, as further described herein, is configured to provide a DC voltage and/or current between layer 767 and layer 765 upon exposure to electromagnetic radiation. It is noted that apparatuses with the same or similar cross section can be configured otherwise.

The apparatus 760 comprises a multilayer junction disposed on a support structure 764. The multilayer junction comprises plasmon-responsive elements 763 disposed on layer 765 and embedded in layer 769 over top of which are disposed layer 767 and 761. The plasmon-responsive elements 763 are configured as ridges. Layer 761 is configured with anti-reflective properties to allow for a predetermined transmission of electromagnetic radiation within predetermined angles relative to the surface of layer 761 within one or more predetermined wavelength ranges from outside into the apparatus. Layer 765 is configured as metallic layer and can provide a plasmon-supporting function, for generating and guiding plasmons. In some embodiments, layer 769 comprises a combination of different layers that provide a desired functionality. In some embodiments, layer 769 comprises an insulating or semiconducting material so that the interface between layer 765 and layer 769 provides a respective metal-insulator or Schottky contact, for example. The ridges can be about less than one to about several hundred nanometers wide, but can have other widths. It is noted that certain optical qualities, for example an ability of the ridges to act as a diffraction grating, may be determined by the width of and/or spacing between the ridges in combination with the wavelength of the light within the apparatus can determine.

Layer 767 comprises a transparent conductive material providing an Ohmic contact with layer 769. Layer 767 comprises a transparent metal oxide, for example. Layer 761 may further be configured to provide protection of the apparatus against predetermined effects on the apparatus otherwise possibly caused by the environment. Layer 761, 767, 769, 765, the plasmon-responsive elements 763 and/or the support structure 764 may comprise crystalline, poly-crystalline and/or amorphous material. The apparatus 760 may be used for photovoltaic applications, for example.

### Example II

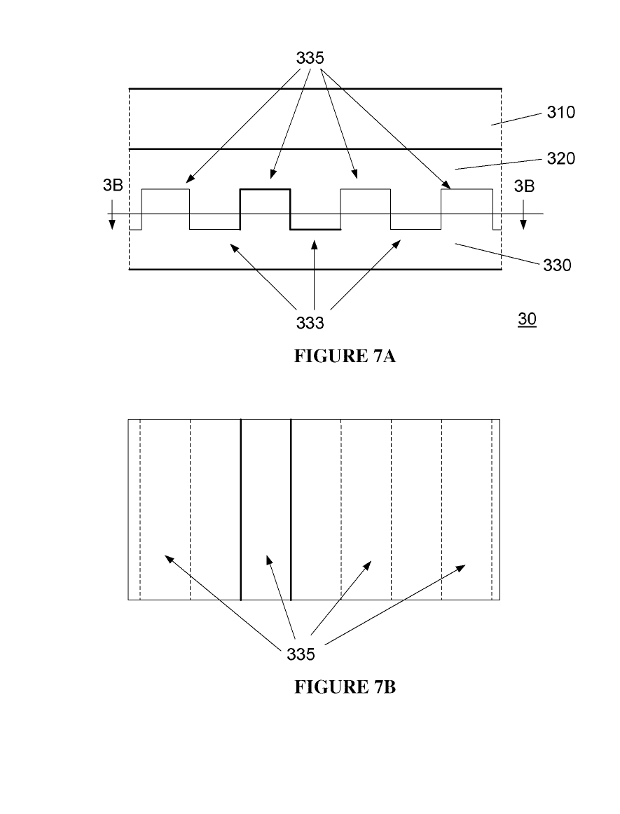

FIG. 7A illustrates a side sectional view of an example apparatus 30 according to an embodiment of the present invention. FIG. 7B illustrates a horizontal sectional view of the apparatus 30 as indicated in FIG. 7A. The apparatus 30 comprises a planar support structure 330 with integrally formed plasmon-responsive elements 335, which are spaced apart by cavities 333. The planar support structure 330 and the plasmon-responsive elements 335 can be made of Au, Ag, Al, Cu, Ti, Ni, Pt or other metallic elements or compounds, for example. The apparatus 30 further comprises a dielectric layer 320, which can be made of TiO₂ or another dielectric material. The relative refractive index for TiO₂ within the visible electromagnetic spectrum is about 2.5. It is noted that some other dielectric materials have similar relative refractive indices in this wavelength range. The interface between the dielectric layer 320 and the plasmon-responsive elements 335 is shaped as illustrated and defines ridges extending perpendicular to the plane of the sectional view of FIG. 7A. The ridges have a rectangular cross section, are about 130 nm high, are about 50 nm wide and disposed at about 100 nm space in between the ridges. The example apparatus 30 may be used as a detector or sensor, a photon-processing device, a solar energy harvesting device or other application, for example. The apparatus 30 is capped with a transparent layer 310 of conductive material. The transparent layer 310 may comprise a transparent conductive material including adequately thin metal layers and/or transparent conductive oxides (TCOs) such as Sn-doped In₂O₃, F or Sb-doped SnO₂, ZnO, Al-, B-, F-, Ga- or In-doped ZnO, Nb-doped TiO₂, Cd₂SnO₄, for example.

The apparatus 30 can be integrally formed in a process including various deposition, masking and etching steps, other processes or combination thereof. The steps can be performed in a controlled atmosphere that is characterized by predetermined ambient temperature, substrate temperature, and/or gas, dust and/or other atmospheric particle composition and corresponding pressures and may vary depending on the process and/or be different during different steps of the process that is used to deposit the apparatus. Different processes may be performed in different atmospheric conditions in the presence of predetermined gases or under predetermined vacuum conditions.

It will be recognized by those skilled in the art that the described structures can, for example, be fabricated by employing standard materials deposition and patterning methods. An aspect for consideration during fabrication is the placement or registration of the plasmon-responsive elements. With appropriate registration, methods such as electron beam lithography, nanoimprint lithography and other high resolution patterning methods can be used to prepare plasmon-responsive elements of predetermined size, shape, and composition in predetermined locations with respect to the plasmon-responsive element. This preparation can be affected at various stages of the fabrication of the plasmon-responsive element.

It is noted that one or more of the described steps may be performed in other ways, for example, by selectively depositing material versus selectively removing material and correspondingly configuring masks as negative masks versus positive masks, for example, or by employing different processes for depositing and/or removing material and/or masks. It is further noted that, depending on the embodiment, other materials than described above may be employed for forming the apparatus.

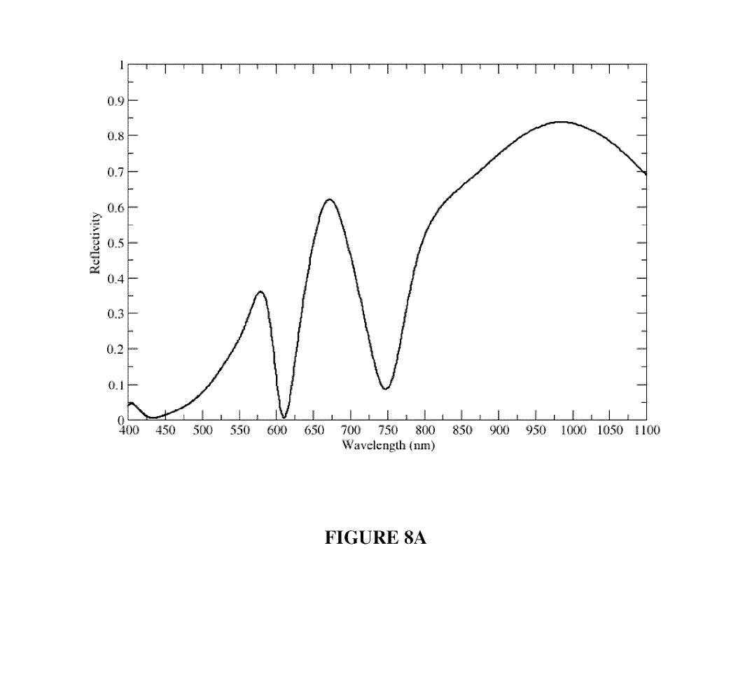

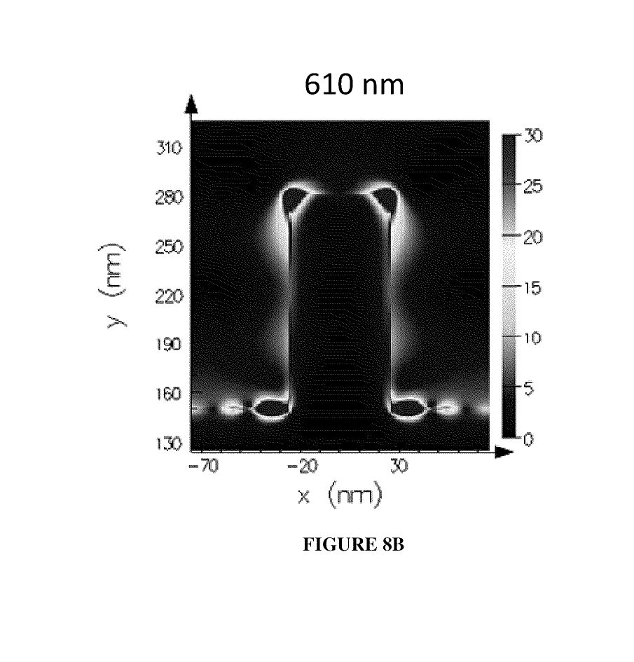

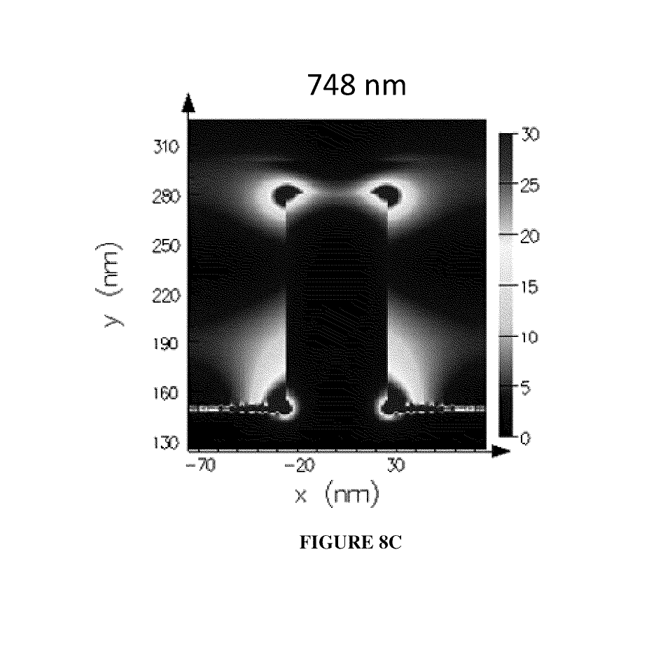

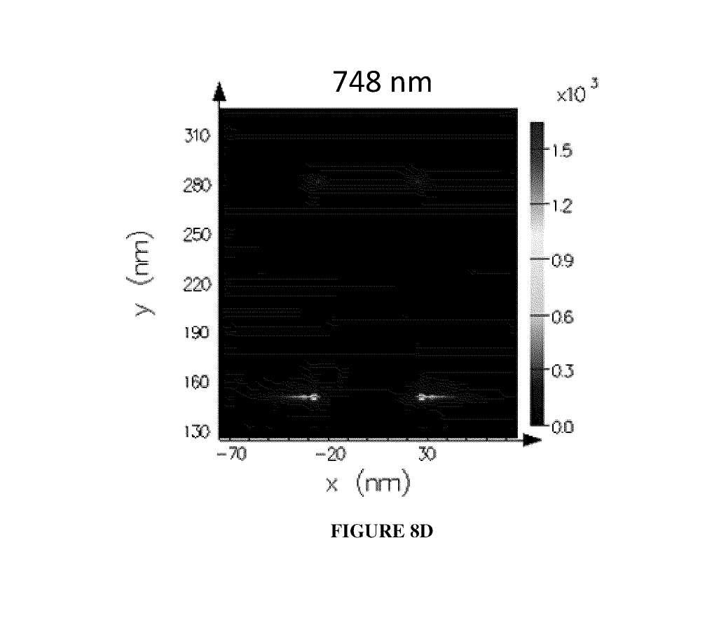

FIG. 8A, FIG. 8B, FIG. 8C and FIG. 8D illustrate operational characteristics determined by finite difference time domain (FDTD) calculations in two dimensions for apparatuses configured as illustrated in FIG. 7A and FIG. 7B. It is noted that the FDTD calculations refer to only the interface between dielectric layer 320 and support structure 330. For this purpose the cross sections of the plasmon-responsive elements are considered to be dimensioned as described above and periodically disposed at about 100 nm. Light is incident at a normal angle with respect to the surface of the transparent conductive layer 310. The illustrated operational characteristics include responses of the apparatus to a broadband wavelength spectrum including wavelengths in the range of about 400 nm to about 1100 nm.

The results of the FDTD simulations shown in FIG. 8A to FIG. 8D illustrate the free-space coupling of radiation to the nanoscale plasmon-responsive elements and to determine the magnitude and spatial profiles of resulting plasmonic fields supported by the plasmon-responsive elements. The FDTD method makes use of experimentally determined frequency-dependent permittivity data for various materials, including a variety of metals such as Au and Ag, as well as for a range of dielectric materials.

Depending on simulation details, substantially perfectly matched layer absorbing boundary conditions and/or periodic boundary conditions are employed for the boundaries of the simulation domain. For two dimensional FDTD simulations, a non-uniform orthogonal grid has been employed for the simulations in which the grid size for metal dielectric boundaries can be as small as about 1.0 nm in the horizontally and about 2.5 nm vertically. To provide better resolution, in some simulations the horizontal grid size is reduced to about 0.25 nm. For three dimensional FDTD simulations, the grid is uniform of dimension about 5.0 nm in the x, y, and z dimensions. The methods employed in performing FDTD simulations would be readily understood. The FDTD calculations employ experimentally determined, frequency-dependent permittivity data for the materials employed in the corresponding apparatus.

FIG. 8A illustrates the reflectivity spectrum of the example apparatus 30 between 400 nm and 1100 nm as determined by FDTD. FIG. 8B illustrates the electric field intensity distribution for one of the plasmon-responsive elements 335 at 610 nm of the apparatus 30 as determined by FDTD. FIG. 8C and FIG. 8D illustrate electric field intensity distributions for one of the plasmon-responsive elements 335 at 748 nm of the apparatus 30 as determined by FDTD. FIG. 8C illustrates arbitrarily scaled electric field intensity distribution, and FIG. 8D illustrates a version thereof that is scaled with respect to the intensity of the incident electromagnetic radiation.

FIG. 8A, demonstrates that incident light of particular wavelengths is preferentially absorbed by the apparatus. For example, the reflectivity of the apparatus 30 exhibits local minima at about 610 nm and about 748 nm. These minima may represent absorption and conversion of light into corresponding plasmons by the apparatus. As can be seen from FIG. 8B, the plasmons generated in the case of 610 nm excitation appear to be localized at upper corners of the plasmon-responsive elements. While the plasmon mode excited by 710 nm shown in FIG. 8C exhibits a similar coupling to the upper corners of the metal ridge, the highest field intensity is found at the bottom corner of the plasmon-responsive element, indicating a strong cavity effect due to the periodicity of the plasmon-responsive elements. As can be seen in FIG. 8D the appropriately scaled intensity distribution demonstrates a local field enhancement of about three orders of magnitude relative to the incident field.

### Example III

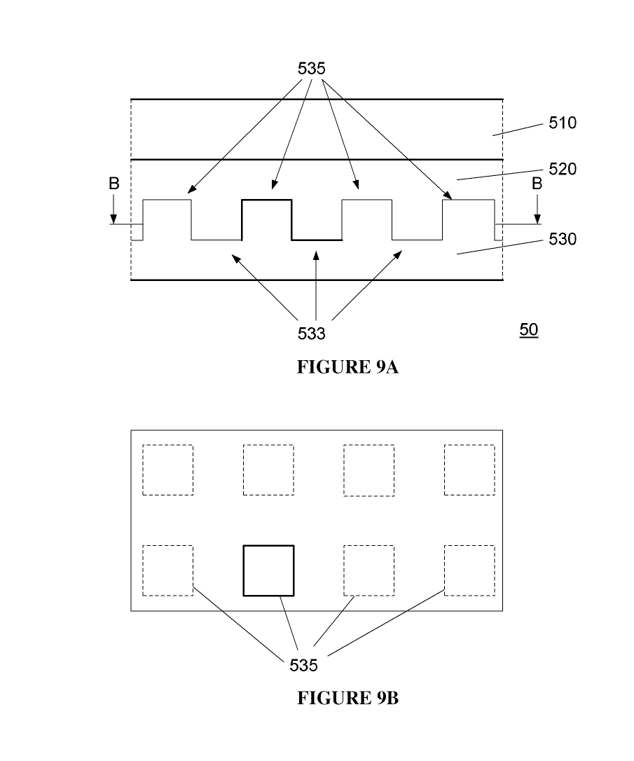

FIG. 9A illustrates a side sectional view of an example apparatus 50 according to an embodiment of the present invention. FIG. 9B illustrates a horizontal sectional view of the apparatus 50 as indicated in FIG. 9A. The apparatus 50 comprises a planar support structure 530 with integrally formed plasmon-responsive elements 535, which are spaced apart by cavities 533. For this embodiment, the planar support structure 530 and the plasmon-responsive elements 535 may comprise Au, Ag, Al, Cu, Ti, Ni, Pt or other metallic elements or compounds, for example. The apparatus 50 further comprises a dielectric layer 520 made of TiO₂ or another dielectric material. The interface between the dielectric layer 520 and the plasmon-responsive elements 535 is shaped as illustrated and defines prismatic plasmon-responsive elements with a substantially quadratic base extending perpendicular to the plane of the sectional view of FIG. 9A. The ridges have a quadratic cross section of about 50 nm by about 50 nm, are about 130 nm high, and are disposed at a spacing of about 80 nm. The example apparatus 50 may be used as a detector or sensor, a photon-processing device, a solar energy harvesting device or other application, for example. The apparatus 50 is capped with a transparent layer 510 of conductive material. The transparent layer 510 may comprise a transparent conductive material including adequately thin metal layers and/or transparent conductive oxides (TCOs) such as Sn-doped In₂O₃, F or Sb-doped SnO₂, ZnO, Al, B, F, Ga or In-doped ZnO, Nb-doped TiO₂, Cd₂SnO₄, for example.

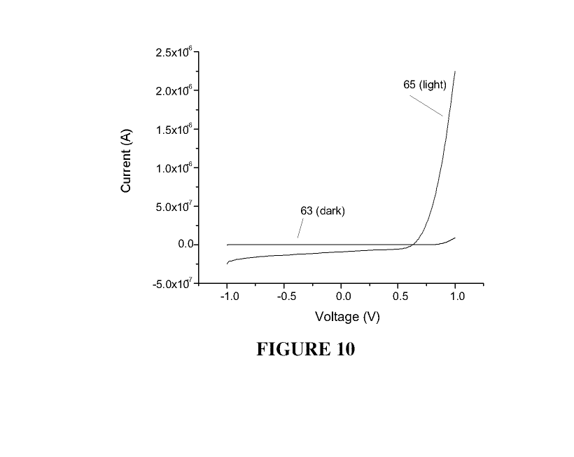

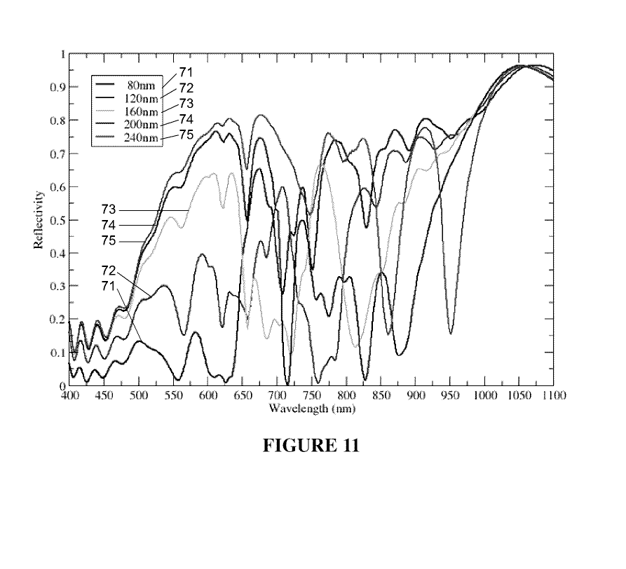

FIG. 10 illustrates current-voltage (I-V) characteristics of the apparatus 50 fabricated in accordance with the following procedure: The apparatus 50 comprises a titanium dioxide layer 520 of about 200 nm thickness deposited on a transparent conductive oxide layer 510 comprising F-doped SnO₂. The TiO₂ deposition can be performed by ion-assisted electron beam evaporation, which, when performed adequately can lead to formation of plasmon-responsive elements due to an intrinsically rough surface that inherently forms in this deposition process. Deposition of a thin gold layer to the top TiO₂ surface results in a nanoscale textured plasmon supporting interface capable of converting light into plasmons in the apparatus. The apparatus 50 can exhibit rectifying ability by forming a Schottky contact at the TiO₂/Au interface. The corresponding apparatus can be employed to form a photovoltaic device.

FIG. 10 illustrates the I-V characteristics 63, 65 under darkness and under illumination of the apparatus 50 with light at about 670 nm. The I-V curve 63 obtained in darkness shows a high degree of asymmetry with a turn-on voltage greater than about 0.75 V. The I-V curve 65 obtained under illumination demonstrates a photovoltaic response with an open-circuit voltage greater than about 0.6 V.

It is further noted that, as described herein, other embodiments of apparatuses according to some embodiments of the present invention may be employed for photovoltaic conversion of light. Example configurations of such apparatuses may include a support structure with nanoscale textured interfaces, adjacent an appropriate barrier dielectric layer and covered by a layer of transparent conductive material. The resulting rectifying structure may, through appropriate choice of materials, represent a Schottky barrier, a metal-insulator-metal (MIM) rectifier, or a metal-insulator-semiconductor-metal (MISM) diode.

### Example IV

FIG. 11 to FIG. 15 illustrate reflectivities of a series of example apparatuses according to embodiments of the present invention. The reflectivities refer to the interface between dielectric layer 520 and support structure 530 of apparatuses based on the apparatus 50 as illustrated in FIG. 9A and FIG. 9B. These example apparatuses exhibit how disordered plasmon-responsive elements can affect reflectivities of the corresponding apparatuses. As a general trend less order causes less reflectivity and hence not considering other photon conversion effects, may implies higher plasmon generation rates. Accordingly some apparatus according to the present invention may be successfully employed in photovoltaic applications.

FIG. 11 illustrates reflectivities versus wavelength of normally incident radiation for different example apparatuses modeled by three-dimensional FDTD methods. The example apparatuses are similar to the apparatus 50 but each has its own distinct distance between the prismatic plasmon-responsive elements, which are about 100 nm high and have a quadratic base of about 50 nm by about 50 nm. The distances between the plasmon-responsive elements are either about 80 nm, about 120 nm, about 160 nm, about 200 nm or about 240 nm. Corresponding reflectivities are indicated by respective reference numerals 71, 72, 73, 74 and 75.

The reflectivities in FIG. 11 represent the reflectivity of light at normal incidence. As can be seen, the reflectivities 71, 72, 73, 74 and 75 indicate a number of trends. For example, as the separation between the plasmon-responsive elements is increased, the ability to generate plasmons with shorter wavelengths is reduced. Specifically, the absorption profile of the apparatuses are altered from a situation in which the coupling efficiency is greater than about 85% for wavelengths shorter than about 630 nm to one in which light in this wavelength range is not coupled efficiently at all. Furthermore, increase in the separation between the plasmon-responsive elements is accompanied by increased coupling efficiency in the wavelength region from about 700 nm to about 900 nm, where relatively narrow bandwidth (resonant) absorption is apparent at plasmon-responsive element separations of about 180 nm and about 200 nm. As can be seen, FIG. 11 demonstrates that it is possible to preferentially couple light of different wavelengths into apparatuses according to embodiments of the present invention by controlling the separation between plasmon-responsive elements.

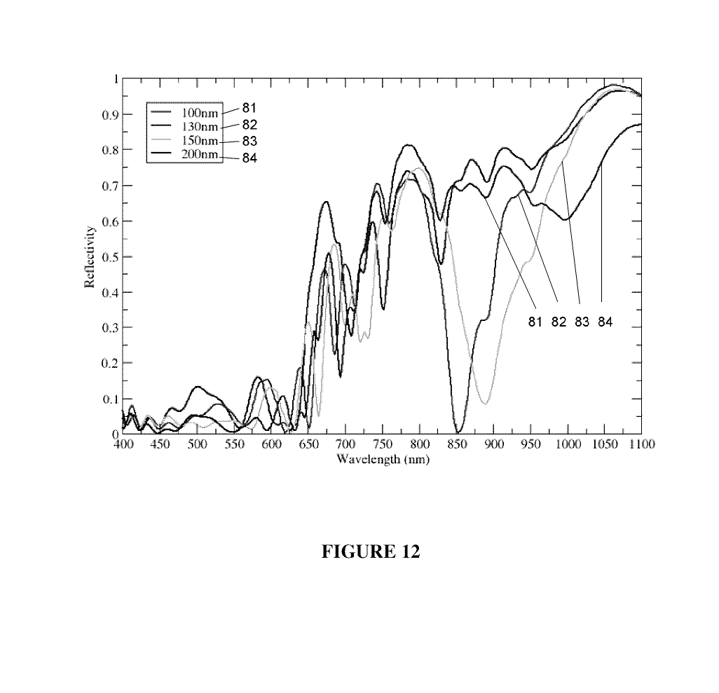

FIG. 12 illustrates reflectivity versus wavelength of normally incident radiation for different example apparatuses modeled by three-dimensional FDTD methods. The example apparatuses are similar to the apparatus 50 but each has its own height of the prismatic plasmon-responsive elements. The plasmon-responsive elements have a quadratic base of about 50 nm by about 50 nm and are separated by about 80 nm. Each apparatus has plasmon-responsive elements that are either about 100 nm, about 130 nm, about 150 nm or about 200 nm high. Corresponding reflectivities are indicated by reference numerals 81, 82, 83 and 84.

FIG. 12 illustrates the operational characteristics of the four apparatuses which exhibit effects on the local field enhancements and absorption properties of prismatic plasmon-responsive elements with a quadratic base and with different heights.

The curves in FIG. 12 represent the reflectivity of incident wavelengths at normal incidence. As can be seen, the reflectivities 81, 82, 83 and 84 indicate a number of trends. For example, altering the height of the plasmon-responsive elements can result in a substantial increase in reflectivity. Specifically, apparatuses with plasmon-reflective elements from about 100 nm to about 130 nm high have decreased reflectivity in the about 850 nm to about 950 nm range at the expense of increased reflectivity in the about 700 nm to about 775 nm range. Increase in height of plasmon-responsive elements to about 150 nm is accompanied by a further shift of reduced reflectivities to longer wavelengths and a slight broadening of the coupling resonance. Further increase in height of the plasmon-reflective elements to about 200 nm results in a decrease in coupling efficiency at longer wavelengths.

It is noted that other aspects regarding reflectivities of example apparatuses with height, width, distance and/or other characteristics may be observed. It is noted that the height and separation of plasmon-responsive elements play a role in the ability to couple radiation into example apparatuses according to the present invention. Furthermore, efficient coupling of predetermined spectra of electromagnetic radiation, including the solar spectrum or other broad or narrow ranges of electromagnetic radiation may be facilitated with apparatuses with predetermined separation, height and aspect ratio of plasmon-reflective elements. As is exhibited, different example apparatuses absorb different quantities of the noted electromagnetic radiation.

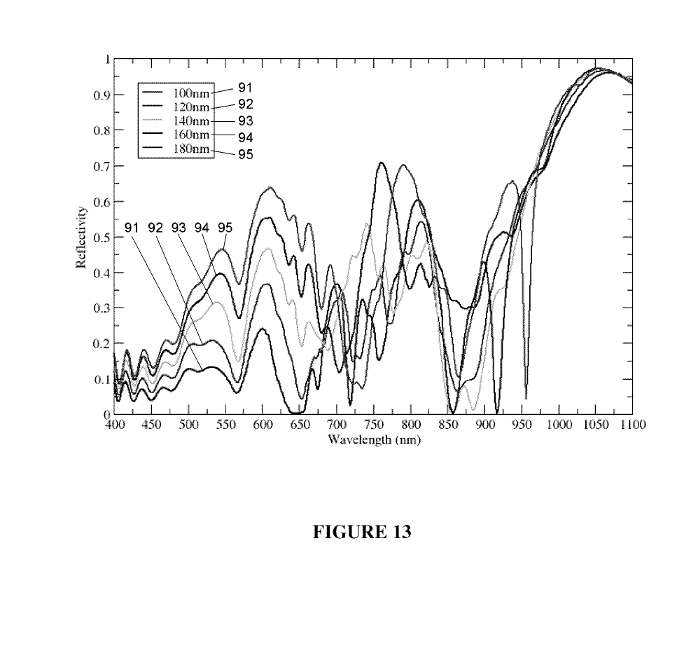

FIG. 13 illustrates reflectivity versus wavelength of normally incident radiation for different example apparatuses modeled by three-dimensional FDTD methods. The example apparatuses are similar to the apparatus 50 but each has its own separation of plasmon-responsive elements and includes plasmon-responsive elements of two different heights. The plasmon-responsive elements have a quadratic base of about 50 nm by about 50 nm. Each apparatus has plasmon-responsive elements that are either about 100 nm, about 120 nm, about 140 nm, about 160 nm, or about 180 nm apart.

Corresponding reflectivities are indicated by reference numerals 91, 92, 93, 94 and 95. The height of the plamon-responsive elements alters between about 130 nm and about 180 nm. As can be seen the example apparatuses according to FIG. 13 in comparison to the previous example apparatuses can capture a larger portion of the impinging electromagnetic wavelength range.

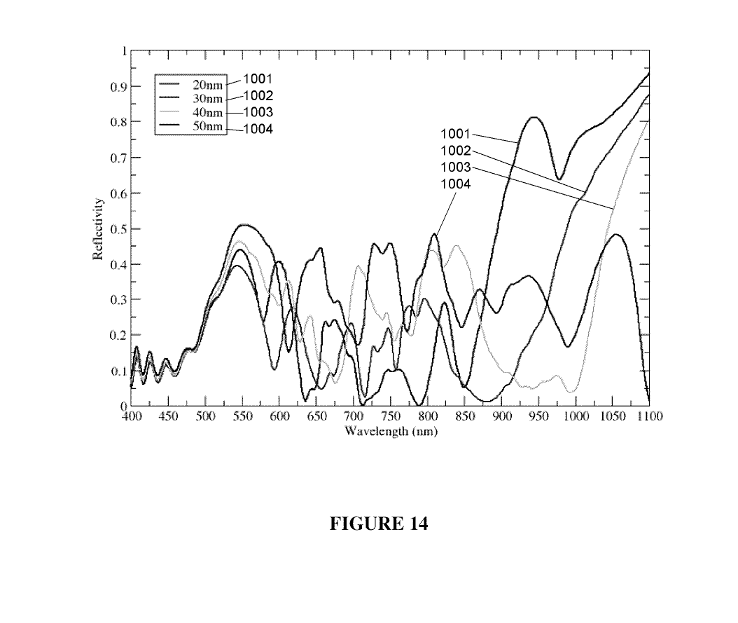

FIG. 14 illustrates reflectivity versus wavelength of normally incident radiation for different example apparatuses modeled by three-dimensional FDTD methods. The example apparatuses are similar to the apparatus 50 but have cylindrical plasmon-responsive elements. Furthermore, the cylindrical plasmon-reflective elements of each apparatus have a predetermined radius and alternating heights. The plasmon-responsive elements are spaced in a quadratic grid at about 110 nm distance between the centers of the axes of the cylindrical plasmon-responsive elements. Each apparatus has plasmon-responsive elements with a radius of either about 20 nm, about 30 nm, about 40 nm, or about 50 nm. Corresponding reflectivities are indicated by reference numerals 1001, 1002, 1003 and 1004. The height of the plamon-responsive elements alters between about 130 nm and about 180 nm. As can be seen the example apparatuses according to FIG. 14 in comparison to the previous example apparatuses can capture a larger portion of the impinging electromagnetic wavelength range.

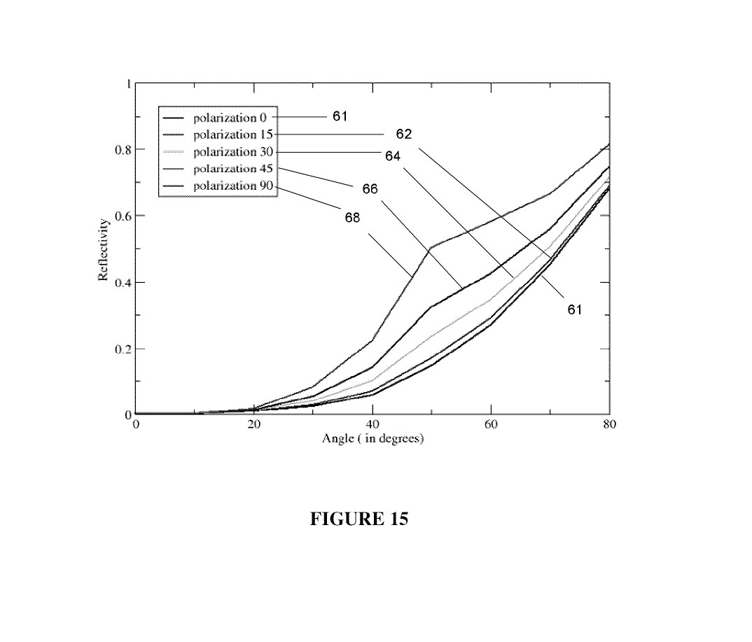

FIG. 15 illustrates reflectivities of the apparatus 50 at about 620 nm depending on the angle of incidence of the incoming light and five different angles 61, 62, 64, 66 and 68 of polarization, corresponding to about 0, 15, 30, 45 and 90 degrees. The reflectivities refer to the interface between dielectric layer 520 and support structure 530. The angle of incidence is measured relative to a direction perpendicular to the surface of the transparent conductive layer 510. FIG. 15 illustrates an aspect of the apparatus 50 and similar apparatuses including their ability to substantially capture radiation of random polarization and at a broad range of incident angles for wavelengths that couple to the apparatus including the plasmon-responsive elements. For example, substantially more than about 90% of the about 620 nm radiation can be captured effectively, independent of polarization, for incident angles less than about 30°. Reflectivity losses increase at larger incident angles at different rates, depending on the incident polarization. It is noted that the reflectivities obtained from the FDTD calculations are single-pass reflectivities and may be increased or reduced by multiple reflections at other interfaces of the apparatus, for example. It is noted that more than about 90% of the incident radiation at about 620 nm can be captured for incidence angles within about ±30°, independent of polarization of the incident light. It is noted that the reflectivity may be reduced even at high angles of incidence by texturing the surface of the transparent conductive layer 510. For example, for a photovoltaic apparatus to be efficient without the need for tracking the sun, the apparatus should be configured to absorb radiation over as broad a range of incident angles of said radiation on the apparatus, as possible.

The reflectivity spectra of the example apparatuses illustrate that quasi-planar metallic nanostructures can be used to convert a substantial portion of wavelength ranges that may be relevant for solar energy conversion into plasmonic modes at a charge-separating interface. The design of the apparatuses aids in developing relatively high electromagnetic field intensities, as well as efficient transport of the generated charges from the combination of the plasmon-responsive elements and the support structure, which can be used as a first external electrical contact, across the dielectric layers to the second electrical contacts of the apparatuses.

### Example V

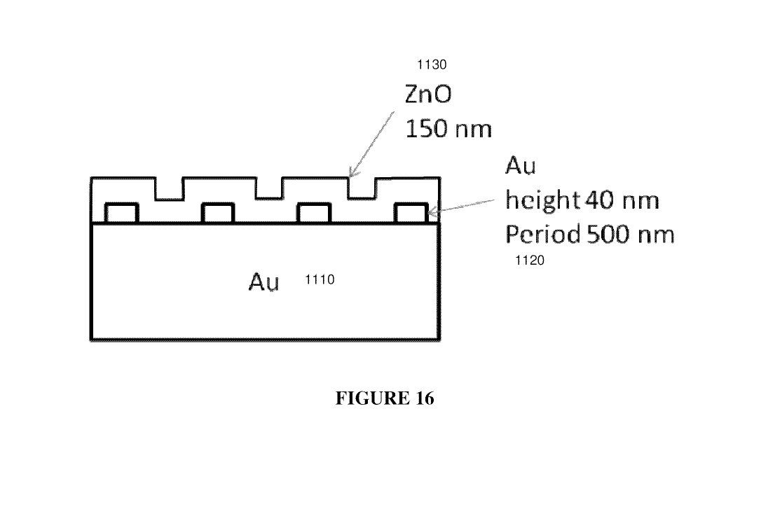

FIG. 16 illustrates a side sectional view of an example apparatus according to an embodiment of the present invention. The apparatus comprises a planar support structure 1110 with integrally formed spaced apart plasmon-responsive elements 1120. For this embodiment, the planar support structure 1110 and the plasmon-responsive elements 1120 are formed from Au. The apparatus further comprises a ZnO layer 1130 deposited on top of the plasmas responsive elements and the planar support structure 1110. For example, this apparatus can be formed by using electron beam lithography for creating 40-nm tall Au plasmon responsive elements on a 120 nm Au film, wherein these plasmon responsive elements are configured to have a periodic spacing of 500 nm. The plasmon responsive elements were then coated with 150 nm ZnO layer by RF sputtering.

During the testing of this apparatus, the reflectivity spectra was collected using an quartz lamp focused down by a 50× microscope objective onto the sample apparatus, wherein the sample apparatus had a 50 μm×50 μm sample area. The reflected spectrum was detected using a fiber-coupled CCD spectrometer, wherein this collected spectra were subsequently normalized to a reference Al film.

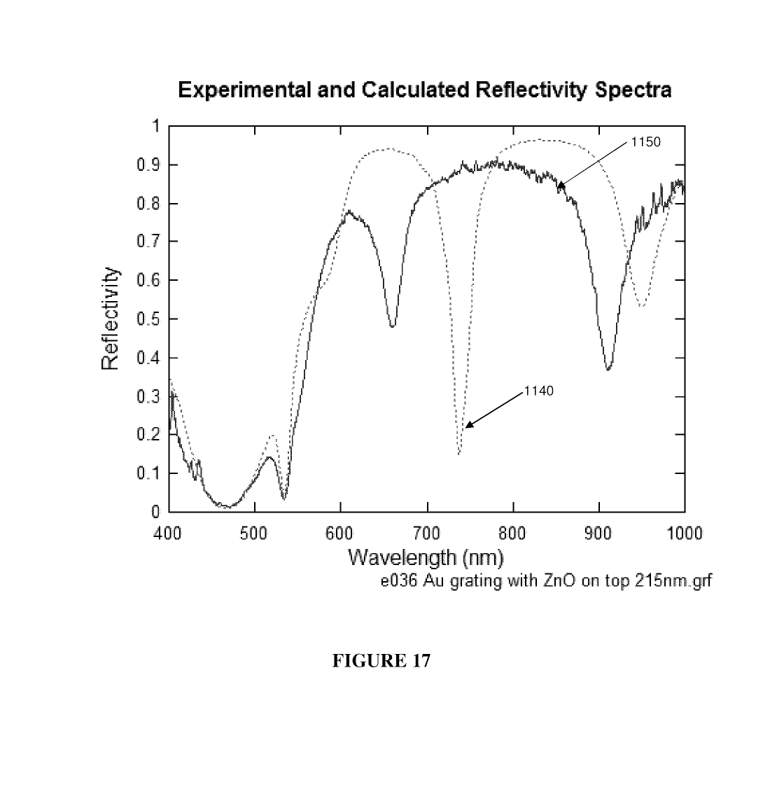

FIG. 17 illustrates the experimental reflectivity spectrum 1140 and the calculated reflectivity spectrum 1150 of the apparatus illustrated in FIG. 16, for a linewidth of 215 nm. As can be seen from FIG. 17, there is good agreement between the experimental and calculated results up to 600 nm, and there is a wavelength offset in the subsequent peaks and valleys between the experimental and calculated extinction spectrums.

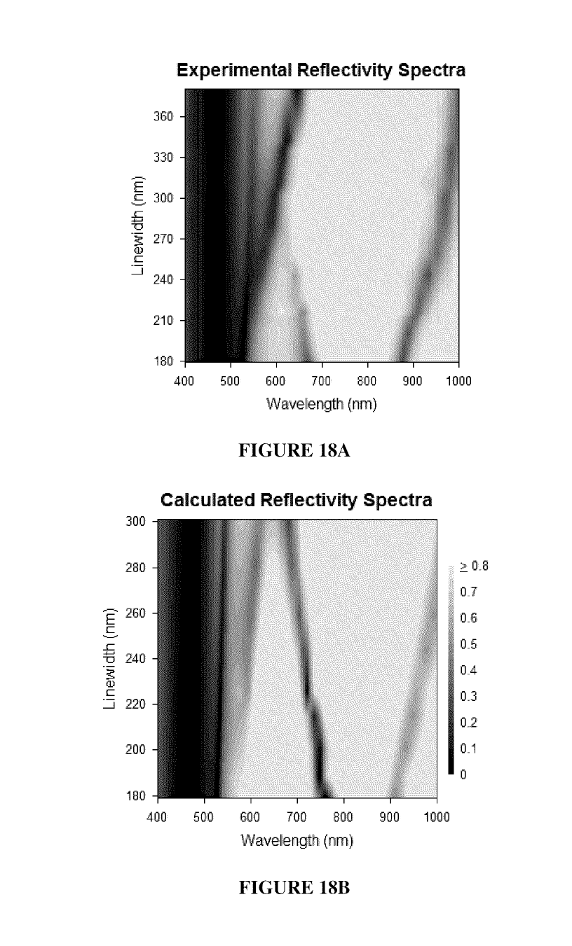

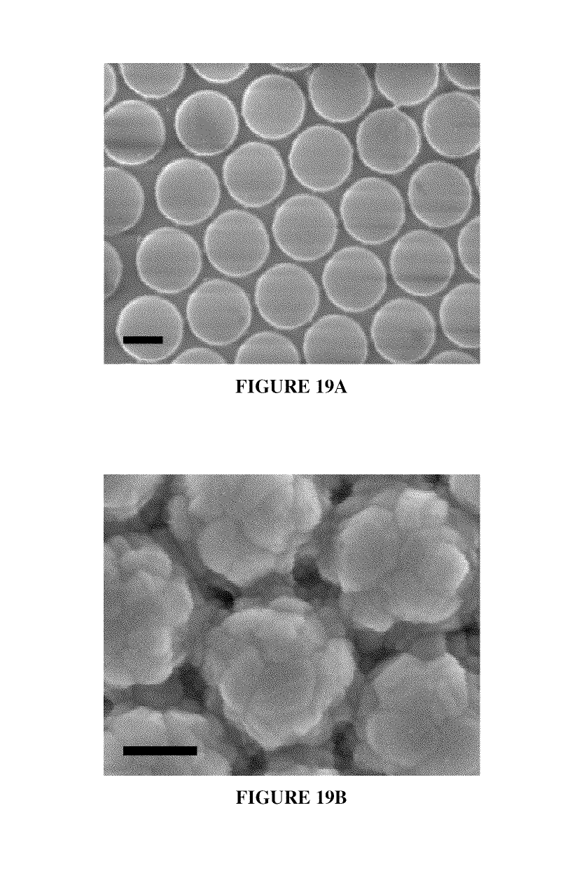

In addition, FIG. 18A illustrates the calculated reflectivity spectra of the apparatus illustrated in FIG. 16, for linewidths from 180 nm to 300 nm. FIG. 18B illustrates the experimental reflectivity spectra of the apparatus illustrated in FIG. 16, also for linewidths from 180 nn to 300 nm. The calculated extinction spectra was determined using finite difference time domain (FDTD) calculation, and as can be identified in FIGS. 18A and 18B there is very good agreement between the experimental results and calculated results in terms of the number of spectral features observed, the positions thereof and the trending of results with varying linewidths.

### Example VI

According to some embodiments, ordered and disordered arrays of nanostructures for aiding in the formation of the plasmon responsive elements, can be constructed using colloidal particles as masking layers. The colloidal particles can be dropcast or spin cast from solution onto a substrate. The solution composition and deposition conditions can be used to tune the dimensions and periodicity of the final structure created from disordered, isolated structures to regularly packed structures with short or long range periodicity. Once deposited, the size of the colloidal particles can be reduced, for example by oxygen plasma etching, to further tune the dimension of the structures they will create. These colloidal particles can serve either as a protective mask during reactive ion etching or as a lift-off mask. For example, arrays of nanopillar or nanoholes can be created on the substrate and conformal deposition techniques utilized to impart the nanostructure to subsequent layers of materials which can be formed to create the apparatus.

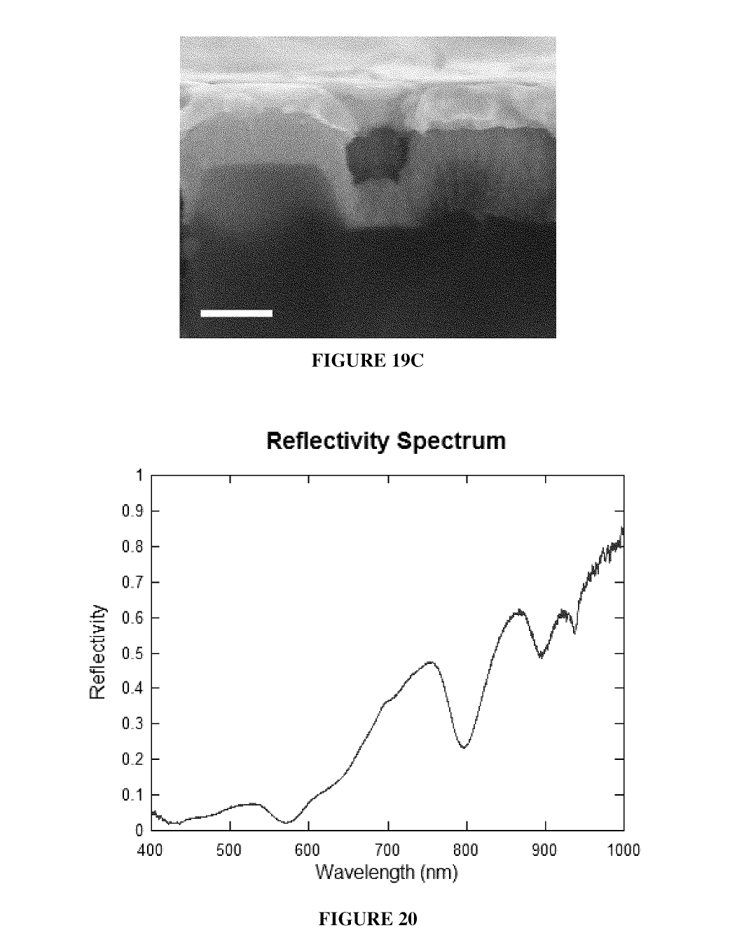

For example, the desired pattern for the plasmas responsive elements, can be prepared in a glass substrate via reactive ion etching in a CHF₃:O₂ plasma. The patterned borosilicate substrates were then coated with 80 nm of 2% Al:ZnO by RF sputtering in 2 mTorr Ar at 400 C, followed by 60 nm of ZnO in 200:1 Ar:O₂ at 300 C. A brief O₂ RF plasma treatment (20 W, 280 mTorr, 10 sec) was used to prepare the ZnO interface prior to Ag contact deposition by thermal evaporation through a shadow mask. FIGS. 19A and 19B shows a scanning electron micrograph showing the patterned borasilicate glass substrate with nanocylinders before and after coating with ZnO:Al, ZnO and Ag layers as defined above. In addition, FIG. 19C shows a cross sectional view of the multilayer coating on the nanocylinders, in accordance with embodiments of the present invention. For reference, in FIGS. 19A, 19B and 19C the scale bars associated therewith are representative of a length of 200 nm.

FIG. 20 illustrates the reflectivity spectrum of the apparatus defined above wherein the electromagnetic radiation has normal incidence on the apparatus. As can be seen from FIG. 20, an apparatus of this configuration has a relatively broad absorption spectrum.

### Example VII

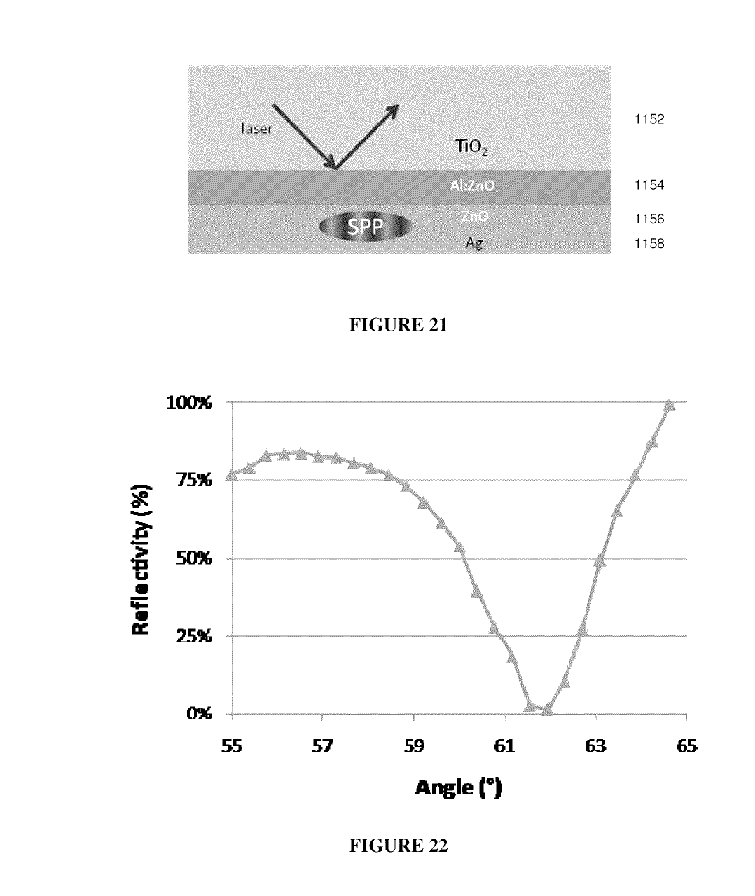

FIG. 21 illustrates an apparatus in accordance with another embodiment of the present invention, wherein this is apparatus is designed in an evanescent wave coupling configuration. The apparatus includes a plurality of layers including a Ag layer 1158, a ZnO layer 1156, a Al:ZnO layer 1154 and a TiO₂ layer 1152, wherein the oxide layers are configured as thin film layer in the nanoscale, thereby enabling surface plasmon polariton generation at the rectifying ZnO—Ag interface. For example, direct excitation of a surface plasmon polariton at the ZnO—Ag interface may be accomplished by evanescent coupling of light from a higher index material, such as from the TiO₂ layer as defined in this example.

For this example, sample apparatuses were prepared by thin film deposition processes on a 30-60-90° rutile prism. First, 80 nm of 2% Al:ZnO: was RF sputtered in Ar at 400° C., followed by 60 nm of ZnO in 200:1 Ar:O₂ at 300° C. A brief O₂ RF plasma treatment (5 W, 40 mTorr, 10 sec) was used to prepare the ZnO interface prior to Ag contact deposition by thermal evaporation through a shadow mask. The ohmic contact was achieved through a large area Ag contact.

During evaluation of the apparatus as illustrated in FIG. 21, by monitoring the reflectivity as a function of angle of incidence for p-polarized 633 nm light, the plasmon generation efficiency can be determined for this device, wherein FIG. 22 shows the experimental data collected in this manner. It can be seen that reflectivity is substantially minimized at an incidence angle of between 61 and 62 degrees.

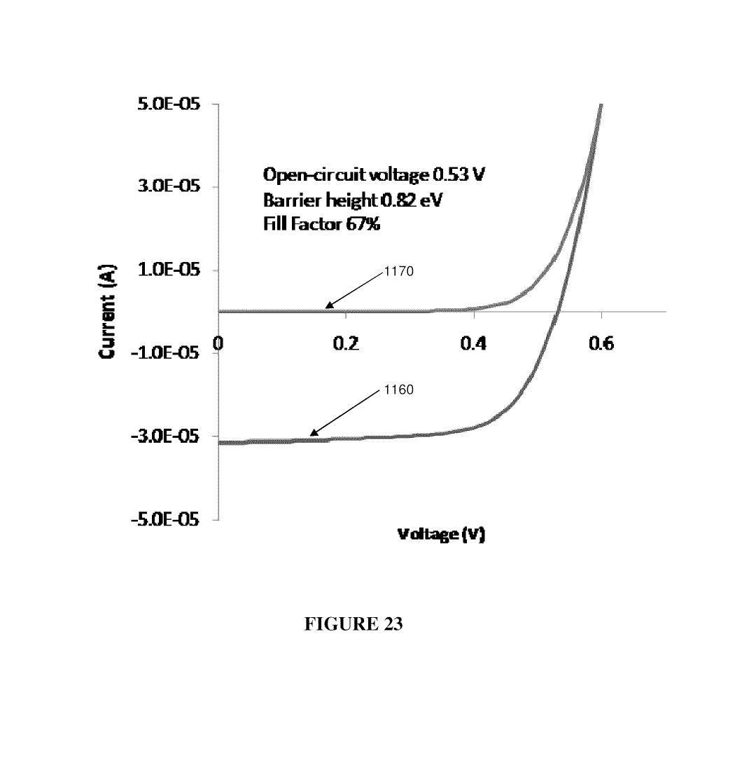

With reference to FIG. 23, the experimental voltage-current response of the above noted device is illustrated. In particular, the first curve 1170 illustrates the voltage-current response of this device in dark conditions and the second curve 1160 illustrates the voltage-current response of this device in illuminated conditions, wherein the angle of incidence of the light is substantially equivalent to that of reflectivity minimum, namely between 61 and 62 degrees.

### Example VIII

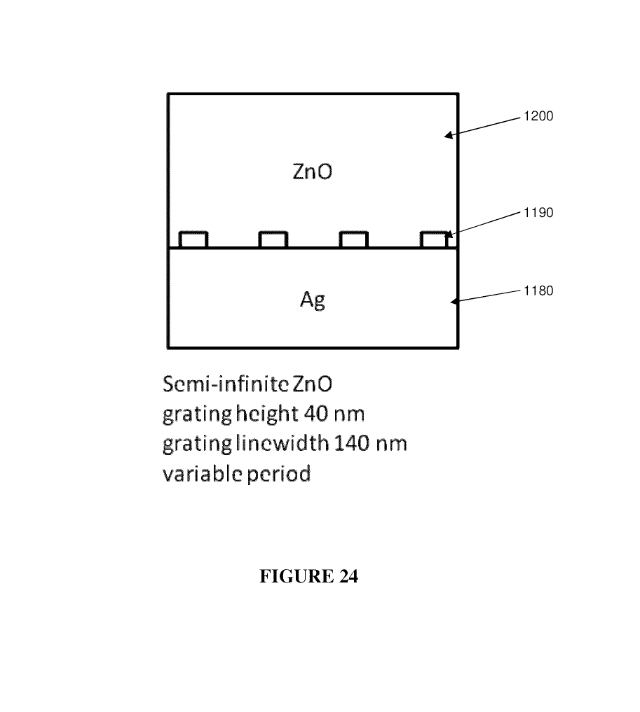

FIG. 24 illustrates a side sectional view of an example apparatus according to an embodiment of the present invention. The apparatus comprises a planar support structure 1180 with integrally formed spaced apart plasmon-responsive elements 1190. For this embodiment, the planar support structure 1180 and the plasmon-responsive elements 1190 are formed from Ag. The apparatus further comprises a ZnO layer 1200 deposited on top of the plasmas responsive elements and the planar support structure 1110. For this example, the plasmon responsive elements are configured to be 40 nm tall and 140 nm wide.

It has been seen that the interactions between different plasmon responsive elements are strongly affected by the spacing between them, namely the period of the spacing. This effect can be modeled by considering a fixed size plasmon responsive element arranged into gratings with varying period.

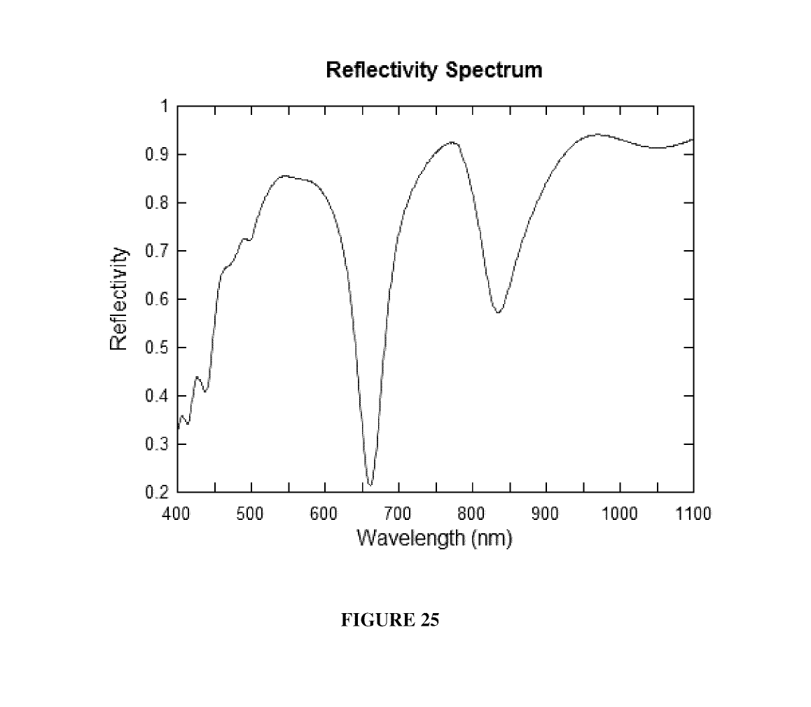

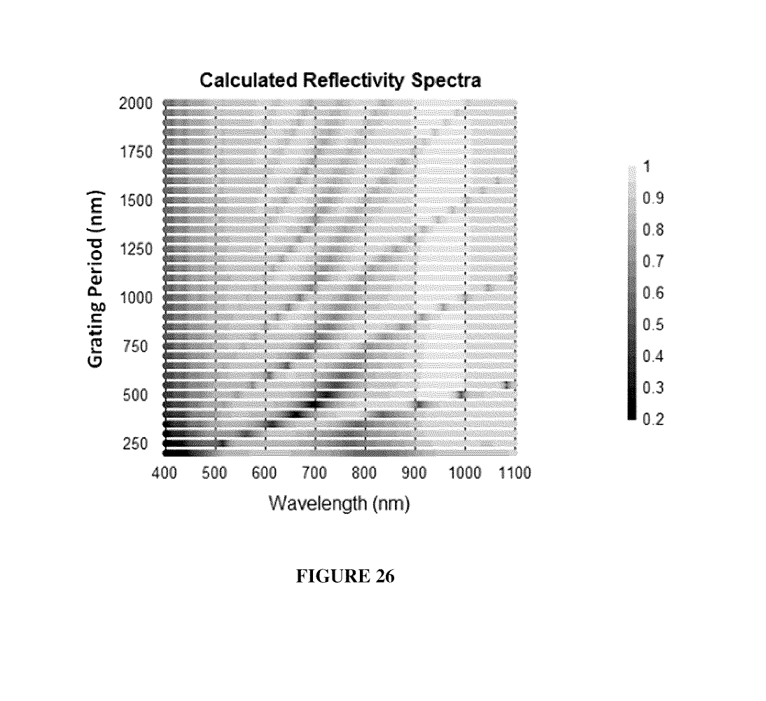

FIG. 25 illustrates the reflectivity spectrum for the apparatus illustrated in FIG. 24, wherein the period of the plasmon responsive elements is 400 nm. Furthermore, reflectivity spectra were calculated by FDTD for a 40 nm tall and 140 nm wide Ag grating covered with ZnO, with periods from 200 to 2000 nm. As can be seen from FIG. 25, there are substantially three wavelength ranges wherein reflectivity of the incident energy appears to be enhanced. In addition, FIG. 26 illustrates the reflectivity spectrum for the above noted apparatus as a function of the period of the plasmon responsive elements.

As can be seen in FIG. 26, the coupling to plasmonic excitations seems to be strongly dependent on the grating period, or spacing of the plasmon responsive elements. It is seen that the absorption peaks disperse to higher wavelengths and increase in number as the period is increased. However, the coupling intensity is seen to be maximized when the period is in the 300 to 600 nm range. Accordingly, interactions on this length scale are thus important for obtaining broadband coupling between the incident light and the apparatus.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. An apparatus for manipulating plasmons, the apparatus comprising:
a. a support structure;
b. two or more plasmon-responsive elements positioned adjacent the support structure, the two or more plasmon-responsive elements configured for interaction with electromagnetic radiation and generation of a plurality of plasmons, wherein at least a first of the two or more plasmon-responsive elements is configured to manipulate interaction of at least some of the plurality of plasmons with at least a second of the two or more plasmon-responsive elements, said two or more plasmon-responsive elements configured as nanoscale structures with a nanoscale spacing therebetween; and
c. a secondary layer disposed on the support structure and the two or more plasmon-responsive elements, said secondary layer forming an interface with the two or more plasmon-responsive elements such that the interface is proximate a location of generation of the plurality of plasmons.

2. The apparatus according to claim 1, wherein at least one of the two or more plasmon-responsive elements are disposed on the support structure or configured as an indentation in the support structure or integrally formed with the support structure.

3. The apparatus according to claim 1, wherein at least one of the two or more plasmon-responsive elements have a shape selected from the group comprising prismatic, cylindrical, pyramidal, spherical, conical and ellipsoidal.

4. The apparatus according to claim 1, wherein the two or more plasmon-responsive elements are spaced apart at a period having a range of nanometers.

5. The apparatus according to claim 1, wherein the two or more plasmon-responsive elements are configured in a planar pattern.

6. The apparatus according to claim 7, wherein the planar pattern has one or more axes of symmetry.

7. The apparatus according to claim 1, wherein the planar pattern has an x direction and a y direction, wherein the two or more plasmon-responsive elements have a first spacing in the x direction and a second spacing in the y direction, wherein the first spacing and second spacing are different.

8. The apparatus according to claim 1, wherein at least one of the two or more plasmon-responsive elements is configured for conversion of at least some of the plurality of plasmons into one or more of a voltage, a current, or a voltage and a current.

9. The apparatus according to claim 8, wherein the apparatus is configured for absorption of a broad range of solar radiation for the conversion.

10. The apparatus according to claim 8, wherein the support structure and the two or more plasmon-responsive elements are formed from a metallic material.

11. The apparatus according to claim 9, wherein the support structure and the two or more plasmon-responsive elements are formed from the same metallic material.

12. The apparatus according to any one of claims 8, 9 and 10, wherein the secondary layer is a semiconductor layer or a dielectric layer.

13. The apparatus according to claim 1, further comprising a trapping mechanism configured to provide containment of the electromagnetic radiation for at least secondary interaction with at least one of the two or more plasmon-responsive elements.

14. The apparatus according to claim 1, wherein at least one of the two or more plasmon-responsive elements has a nano-scale extension in at least one dimension.

15. A method for fabricating an apparatus for manipulating plasmons, the method comprising the steps of:
a. fabricating a support structure;
b. positioning two or more plasmon-responsive elements on the support structure, the two or more plasmon-responsive elements configured for interaction with electromagnetic radiation and generation of a plurality of plasmons, wherein at least a first of the two or more plasmon-responsive elements is configured to manipulate interaction of at least some of the plurality of plasmons with at least a second of the two or more plasmon-responsive elements, said two or more plasmon-responsive elements configured as nanoscale structures with a nanoscale spacing therebetween; and
c. disposing a secondary layer on the support structure and the two or more plasmon-responsive elements, said secondary layer forming an interface with the two or more plasmon-responsive elements such that the interface is proximate a location of generation of the plurality of plasmons.

16. The method according to claim 15, wherein positioning the two or more plasmon-responsive elements comprises modifying the support structure for forming the two or more plasmon-responsive elements.

17. The method according to claim 16, wherein modifying includes removal of at least some of the support structure thereby defining a surface area of the plasmon-responsive element.

18. The method according to claim 15, wherein at least one of the two or more plasmon-responsive elements have a shape selected from the group comprising prismatic, cylindrical, pyramidal, spherical, conical and ellipsoidal.

19. The method according to claim 15, wherein the two or more plasmon-responsive elements are spaced apart at a period having a range of nanometers.

20. The method according to claim 15, wherein the two or more plasmon-responsive elements are configured in a planar pattern.

21. The method according to claim 20, wherein the planar pattern has one or more axes of symmetry.

22. The method according to claim 20, wherein the planar pattern has an x direction and a y direction, wherein the two or more plasmon-responsive elements have a first spacing in the x direction and a second spacing in the y direction, wherein the first spacing and second spacing are different.
